(19) United States
(12) Patent Application Publication
(10) Pub. No.: US 2023/0268971 A1
(43) Pub. Date: Aug. 24, 2023

(54) METHOD AND APPARATUS FOR UL TRANSMISSION

(71) Applicant: Samsung Electronics Co., Ltd., Suwon-si (KR)

(72) Inventors: Md. Saifur Rahman, Plano, TX (US); Eko Onggosanusi, Coppell, TX (US)

(21) Appl. No.: 18/163,825

(22) Filed: Feb. 2, 2023

Related U.S. Application Data
(60) Provisional application No. 63/311,803, filed on Feb. 18, 2022.
(60) Provisional application No. 63/442,337, filed on Jan. 31, 2023.

(51) Int. Cl. H04B 7/06; H04B 7/08; H04W 72/21

(52) U.S. Cl. CPC H04B 7/0691; H04B 7/0874; H04W 72/21; H04B 7/0848

(57) ABSTRACT

Apparatuses and methods for uplink (UL) transmission are provided. A method for operating a user equipment (UE) includes receiving information about an UL transmission based on X panels. The method further includes identifying, based on the information, for each layer l of the UL transmission, nₗ panels among the X panels, where v is a number of layers of the UL transmission; determining the UL transmission based on the identified nₗ panels for each layer l; and transmitting the UL transmission based on the identified nₗ panels for each layer l. The UL transmission corresponds to one of a single panel (SP) transmission from one of the X panels, a simultaneous transmission from multiple of the X panels (STxMP), or a combination of the SP and STxMP, where a set S₁ of the X panels is used for the SP transmission and a set S₂ of the X panels is used for the STxMP.

### CROSS-REFERENCE TO RELATED APPLICATION AND CLAIM OF PRIORITY

This application claims priority under 35 U.S.C. § 119(e) to U.S. Provisional Patent Application No. 63/311,803 filed on Feb. 18, 2022, and U.S. Provisional Patent Application No. 63/442,337 filed on Jan. 31, 2023. The above-identified provisional patent applications are hereby incorporated by reference in their entirety.

### TECHNICAL FIELD

The present disclosure relates generally to wireless communication systems and, more specifically, to uplink transmission.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

This disclosure relates to apparatuses and methods for uplink transmission.

In one embodiment, a user equipment (UE) is provided. The UE includes a transceiver configured to receive information about an uplink (UL) transmission based on X panels. Each panel of the X panels includes a group of antenna ports and X>1. The UE further includes a processor operably coupled to the transceiver. The processor, based on the information, is configured to identify, for each layer l of the UL transmission, nₗ panels among the X panels, where nₗ≤X, l=1, . . . , v and v is a number of layers of the UL transmission, and determine the UL transmission based on the identified nₗ panels for each layer l. The transceiver is further configured to transmit the UL transmission based on the identified nₗ panels for each layer l. The UL transmission corresponds to one of a single panel (SP) transmission from one of the X panels, a simultaneous transmission from multiple of the X panels (STxMP), or a combination of the SP and STxMP, where a set S₁ of the X panels is used for the SP transmission and a set S₂ of the X panels is used for the STxMP.

In another embodiment, a method for operating a UE is provided. The method includes receiving information about an UL transmission based on X panels. Each panel of the X panels includes a group of antenna ports and X>1. The method further includes identifying, based on the information, for each layer l of the UL transmission, nₗ panels among the X panels, where nₗ≤X, l=1, . . . , v, and v is a number of layers of the UL transmission; determining the UL transmission based on the identified nₗ panels for each layer l; and transmitting the UL transmission based on the identified nₗ panels for each layer l. The UL transmission corresponds to one of a single panel (SP) transmission from one of the X panels, a simultaneous transmission from multiple of the X panels (STxMP), or a combination of the SP and STxMP, where a set S₁ of the X panels is used for the SP transmission and a set S₂ of the X panels is used for the STxMP.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIGS. 4 and 5 illustrate example wireless transmit and receive paths according to embodiments of the present disclosure;

FIG. 6 illustrates an example antenna blocks or arrays forming beams according to embodiments of the present disclosure;

FIG. 7 illustrates an example antenna panel according to embodiments of the present disclosure;

FIG. 8 illustrates another example antenna panel according to embodiments of the present disclosure;

FIG. 9 illustrates an example antenna port layout according to embodiments of the present disclosure;

FIG. 10 illustrates an uplink transmission scheme according to embodiments of the present disclosure;

FIG. 11 illustrates another uplink transmission scheme according to embodiments of the present disclosure;

FIG. 12 illustrates yet another uplink transmission scheme according to embodiments of the present disclosure;

FIG. 13 illustrates still another uplink transmission scheme according to embodiments of the present disclosure; and

FIG. 14 illustrates an example method for uplink transmission in a wireless communication system according to embodiments of the present disclosure.

### DETAILED DESCRIPTION

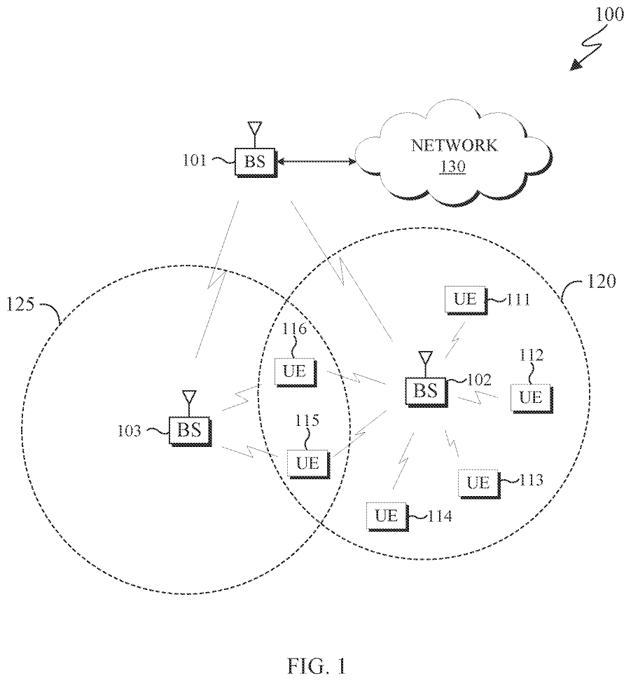

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged system or device.

The following documents and standards descriptions are hereby incorporated by reference into the present disclosure as if fully set forth herein: 3GPP TS 36.211 v17.0.0, “E-UTRA, Physical channels and modulation” (herein “REF 1”); 3GPP TS 36.212 v17.0.0, “E-UTRA, Multiplexing and Channel coding” (herein “REF 2”); 3GPP TS 36.213 v17.0.0, “E-UTRA, Physical Layer Procedures” (herein “REF 3”); 3GPP TS 36.321 v17.0.0, “E-UTRA, Medium Access Control (MAC) protocol specification” (herein “REF 4”); 3GPP TS 36.331 v17.0.0, “E-UTRA, Radio Resource Control (RRC) protocol specification” (herein “REF 5”); 3GPP TS 38.211 v17.0.0, “NR, Physical channels and modulation” (herein “REF 6”); 3GPP TS 38.212 v17.0.0, “NR, Multiplexing and Channel coding” (herein “REF 7”); 3GPP TS 38.213 v17.0.0, “NR, Physical Layer Procedures for Control” (herein “REF 8”); 3GPP TS 38.214 v17.0.0, “NR, Physical Layer Procedures for Data” (herein “REF 3”); 3GPP TS 38.215 v17.0.0, “NR, Physical Layer Measurements” (herein “REF 10”); 3GPP TS 38.321 v17.0.0, “NR, Medium Access Control (MAC) protocol specification” (herein “REF 11”); 3GPP TS 38.331 v17.0.0, “NR, Radio Resource Control (RRC) Protocol Specification (herein REF 12)”.

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), gNB, a macrocell, a femtocell, a WiFi access point (AP), or other wirelessly enabled devices. Base stations may provide wireless access in accordance with one or more wireless communication protocols, e.g., 5G 3GPP New Radio Interface/Access (NR), long term evolution (LTE), LTE advanced (LTE-A), High Speed Packet Access (HSPA), Wi-Fi 802.11 a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for uplink transmission. In certain embodiments, one or more of the BSs 101-103 include circuitry, programing, or a combination thereof for uplink transmission.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

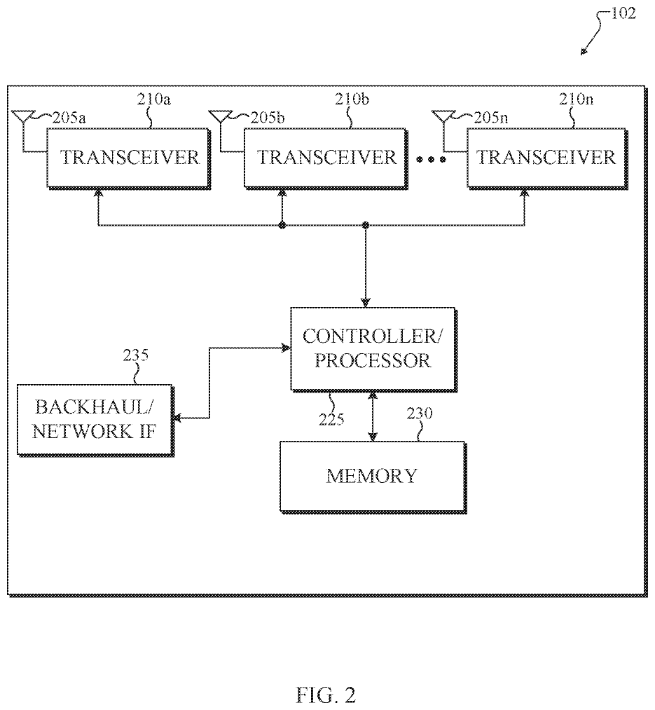

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for uplink transmission. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

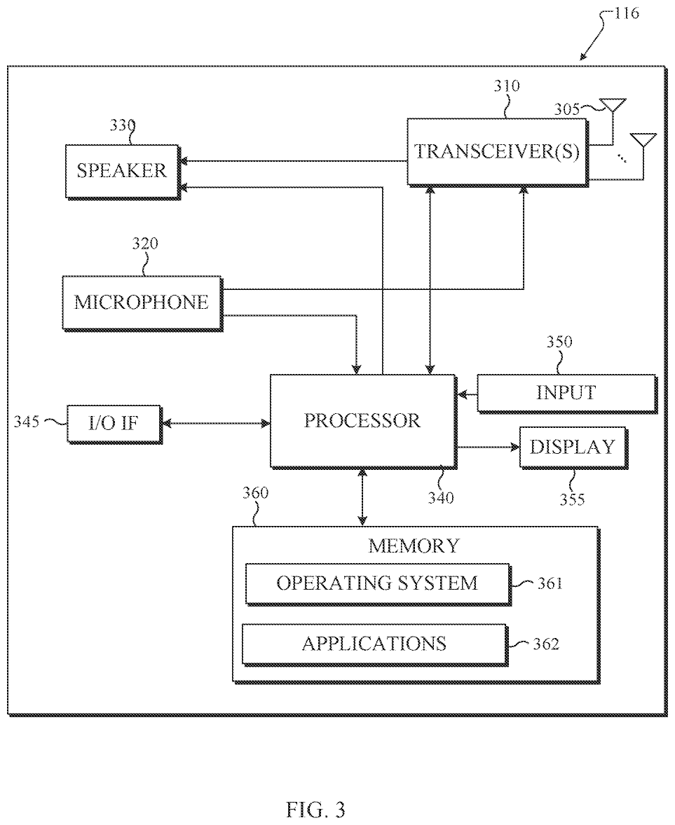

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

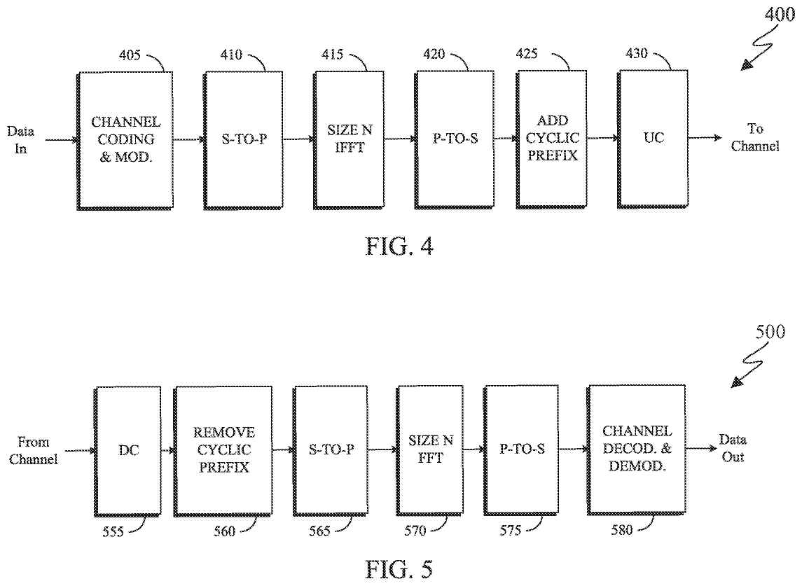

FIG. 4 and FIG. 5 illustrate example wireless transmit and receive paths according to this disclosure. In the following description, a transmit path 400, of FIG. 4, may be described as being implemented in a BS (such as the BS 102), while a receive path 500, of FIG. 5, may be described as being implemented in a UE (such as a UE 116). However, it may be understood that the receive path 500 can be implemented in a BS and that the transmit path 400 can be implemented in a UE. In some embodiments, the receive path 500 is configured to support uplink transmission as described in embodiments of the present disclosure.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the down-converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 515 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

The 3GPP NR specification supports up to 32 CSI-RS antenna ports which enable an eNB (or gNB) to be equipped with a large number of antenna elements (such as 64 or 128). In this case, a plurality of antenna elements is mapped onto one CSI-RS port. For next generation cellular systems such as 5G, the maximum number of CSI-RS ports can either remain the same or increase. For UL transmission, the 3GPP specification supports 1, 2, or 4 SRS antenna ports in one SRS resource, where each SRS antenna port can be mapped to one or multiple antenna elements at the UE.

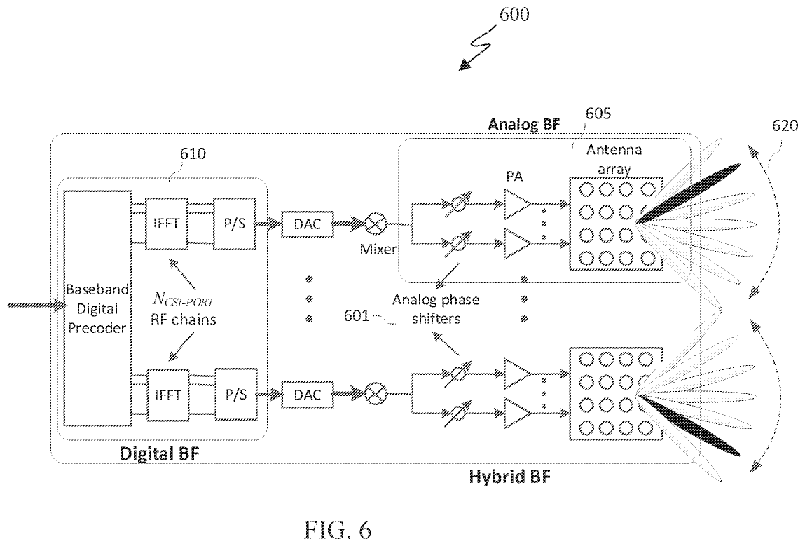

FIG. 6 illustrates an example antenna blocks or arrays 600 according to embodiments of the present disclosure. The embodiment of the antenna blocks or arrays 600 illustrated in FIG. 6 is for illustration only. FIG. 6 does not limit the scope of this disclosure to any particular implementation of the antenna blocks or arrays.

For mmWave bands, although the number of antenna elements can be larger for a given form factor, the number of CSI-RS ports—which can correspond to the number of digitally precoded ports—tends to be limited due to hardware constraints (such as the feasibility to install a large number of ADCs/DACs at mmWave frequencies) as illustrated in FIG. 6. In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports NCSI-PORT. A digital beamforming unit 610 performs a linear combination across NCSI-PORT analog beams to further increase precoding gain. While analog beams are wideband (hence not frequency-selective), digital precoding can be varied across frequency sub-bands or resource blocks.

Since the above system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL transmit (TX) beam (also termed “beam indication”), measuring at least one reference signal for calculating and performing beam reporting (also termed “beam measurement” and “beam reporting”, respectively), and receiving a DL or UL transmission via a selection of a corresponding receive (RX) beam.

The above system is also applicable to higher frequency bands such as >52.6 GHz (also termed the FR4). In this case, the system can employ only analog beams. Due to the O2 absorption loss around 60 GHz frequency (˜10 dB additional loss @100 m distance), larger number of and sharper analog beams (hence larger number of radiators in the array) will be needed to compensate for the additional path loss.

In NR, two transmission schemes are supported for PUSCH: codebook based transmission and non-codebook based transmission. The UE is configured with codebook based transmission when the higher layer parameter txConfig in pusch-Config is set to ‘codebook’, the UE is configured non-codebook based transmission when the higher layer parameter txConfig is set to ‘nonCodebook’.

According to Section 6.1.1.1 [REF9], the following is supported for codebook based UL transmission.

For codebook based transmission, PUSCH can be scheduled by DCI format 0_0, DCI format 0_1, DCI format 0_2 or semi-statically configured to operate according to Clause 6.1.2.3 [REF9]. If this PUSCH is scheduled by DCI format 01, DCI format 0_2, or semi-statically configured to operate according to Clause 6.1.2.3 [REF9], the UE determines its PUSCH transmission precoder based on SRI, TPMI and the transmission rank, where the SRI, TPMI and the transmission rank are given by DCI fields of SRS resource indicator and Precoding information and number of layers in clause 7.3.1.1.2 and 7.3.1.1.3 of [5, REF] for DCI format 0_1 and 0_2 or given by srs-ResourceIndicator and precodingAndNumberOfLayers according to clause 6.1.2.3. The SRS-ResourceSet(s) applicable for PUSCH scheduled by DCI format 0_1 and DCI format 0_2 are defined by the entries of the higher layer parameter srs-ResourceSetToAddModList and srs-ResourceSetToAddModListDCI-0-2 in SRS-config, respectively. Only one SRS resource set can be configured in srs-ResourceSetToAddModList with higher layer parameter usage in SRS-ResourceSet set to ‘codebook’, and only one SRS resource set can be configured in srs-ResourceSetToAddModListDCI-0-2 with higher layer parameter usage in SRS-ResourceSet set to ‘codebook’. The TPMI is used to indicate the precoder to be applied over the layers {0 . . . v−1} and that corresponds to the SRS resource selected by the SRI when multiple SRS resources are configured, or if a single SRS resource is configured TPMI is used to indicate the precoder to be applied over the layers {0 . . . v−1} and that corresponds to the SRS resource. The transmission precoder is selected from the uplink codebook that has a number of antenna ports equal to higher layer parameter nrofSRS-Ports in SRS-Config, as defined in Clause 6.3.1.5 of [4, TS 38.211]. When the UE is configured with the higher layer parameter txConfig set to ‘codebook’, the UE is configured with at least one SRS resource. The indicated SRI in slot n is associated with the most recent transmission of SRS resource identified by the SRI, where the SRS resource is prior to the PDCCH carrying the SRI.

For codebook based transmission, the UE determines its codebook subsets based on TPMI and upon the reception of higher layer parameter codebookSubset in pusch-Config for PUSCH associated with DCI format 0_1 and codebookSubsetDCI-0-2 in pusch-Config for PUSCH associated with DCI format 0_2 which may be configured with ‘fullyAndPartialAndNonCoherent’, or ‘partialAndNonCoherent’ or ‘nonCoherent’ depending on the UE capability. When higher layer parameter ul-FullPowerTransmission is set to ‘fullpowerMode2’ and the higher layer parameter codebookSubset or the higher layer parameter codebookSubsetForDCI-Format0-2 is set to ‘partialAndNonCoherent’, and when the SRS-resourceSet with usage set to “codebook” includes at least one SRS resource with 4 ports and one SRS resource with 2 ports, the codebookSubset associated with the 2-port SRS resource is ‘nonCoherent’. The maximum transmission rank may be configured by the higher layer parameter maxRank in pusch-Config for PUSCH scheduled with DCI format 0_1 and maxRank-ForDCIFormat0_2 for PUSCH scheduled with DCI format 0_2.

A UE reporting its UE capability of ‘partialAndNonCoherent’ transmission shall not expect to be configured by either codebookSubset or codebookSubsetForDCI-Format0-2 with ‘fullyAndPartialAndNonCoherent’.

A UE reporting its UE capability of ‘nonCoherent’ transmission shall not expect to be configured by either codebookSubset or codebookSubsetForDCI-Format0-2 with ‘fullyAndPartialAndNonCoherent’ or with ‘partialAndNonCoherent’.

A UE shall not expect to be configured with the higher layer parameter codebookSubset or the higher layer parameter codebookSubsetForDCI-Format0-2 set to ‘partialAndNonCoherent’ when higher layer parameter nrofSRS-Ports in an SRS-ResourceSet with usage set to ‘codebook’ indicates that the maximum number of the configured SRS antenna ports in the SRS-ResourceSet is two.

For codebook based transmission, only one SRS resource can be indicated based on the SRI from within the SRS resource set. Except when higher layer parameter ul-FullPowerTransmission is set to ‘fullpowerMode2’, the maximum number of configured SRS resources for codebook based transmission is 2. If aperiodic SRS is configured for a UE, the SRS request field in DCI triggers the transmission of aperiodic SRS resources.

A UE shall not expect to be configured with higher layer parameter ul-FullPowerTransmission set to ‘fullpowerMode1’ and codebookSubset or codebookSubsetDCI-0-2 set to ‘fullAndPartialAndNonCoherent’ simultaneously.

The UE shall transmit PUSCH using the same antenna port(s) as the SRS port(s) in the SRS resource indicated by the DCI format 0_1 or 0_2 or by configuredGrantConfig according to clause 6.1.2.3.

The DM-RS antenna ports in Clause 6.4.1.1.3 of [4, TS38.211] are determined according to the ordering of DM-RS port(s) given by Tables 7.3.1.1.2-6 to 7.3.1.1.2-23 in Clause 7.3.1.1.2 of [5, TS 38.212].

Except when higher layer parameter ul-FullPowerTransmission is set to ‘fullpowerMode2’, when multiple SRS resources are configured by SRS-ResourceSet with usage set to ‘codebook’, the UE shall expect that higher layer parameters nrofSRS-Ports in SRS-Resource in SRS-ResourceSet shall be configured with the same value for all these SRS resources.

In the remainder of the present disclosure, ‘fullAndPartialAndNonCoherent’, ‘partialAndNonCoherent’, and ‘Non-Coherent’ are referred to codebookSubsets depending on three coherence type/capability, where the term ‘coherence’ implies all or a subset of antenna ports at the UE that can be used to transmit a layer coherently. In particular,
the term ‘full-coherence’ (FC) implies all antenna ports at the UE that can be used to transmit a layer coherently.
the term ‘partial-coherence’ (PC) implies a subset (at least two but less than all) of antenna ports at the UE that can be used to transmit a layer coherently.
the term ‘non-coherence’ (NC) implies only one antenna port at the UE that can be used to transmit a layer.

When the UE is configured with codebookSubset=‘fullAndPartialAndNonCoherent’, the UL codebook includes all three types (FC, PC, NC) of precoding matrices; when the UE is configured with codebookSubset=‘partialAndNonCoherent’, the UL codebook includes two types (PC, NC) of precoding matrices; and when the UE is configured with codebookSubset=‘nonCoherent’, the UL codebook includes only one type (NC) of precoding matrices.

According to Section 6.3.1.5 of REF7, for non-codebook-based UL transmission, the precoding matrix _{W} equals the identity matrix. For codebook-based UL transmission, the precoding matrix _{W} is given by _{W=1} for single-layer transmission on a single antenna port, otherwise by Table 1 to Table 6, which are copied below.

The rank (or number of layers) and the corresponding precoding matrix _{W} are indicated to the UE using TRI and TPMI, respectively. In one example, this indication is joint via a field ‘Precoding information and number of layers’ in DCI, e.g., using DCI format 0_1. In another example, this indication is via higher layer RRC signaling. In one example, the mapping between a field ‘Precoding information and number of layers’ and TRI/TPMI is according to Section 7.3.1.1.2 of [REF10].

TABLE 1
Precoding matrix W for single-layer transmission using two antenna ports.

| TPMI | W | | | | | | | |
|---|---|---|---|---|---|---|---|---|
| index | (ordered from left to right in increasing order of TPMI index) | | | | | | | |
| 0-5 | $\frac{1}{\sqrt{2}} [ \begin{matrix}1 \\ 0\end{matrix} ]$ | $\frac{1}{\sqrt{2}} [ \begin{matrix}0 \\ 1\end{matrix} ]$ | $\frac{1}{\sqrt{2}} [ \begin{matrix}1 \\ 1\end{matrix} ]$ | $\frac{1}{\sqrt{2}} [ \begin{matrix}1 \\ - 1\end{matrix} ]$ | $\frac{1}{\sqrt{2}} [ \begin{matrix}1 \\ j\end{matrix} ]$ | $\frac{1}{\sqrt{2}} [ \begin{matrix}1 \\ - j\end{matrix} ]$ | — | — |

TABLE 2
Precoding matrix W for single-layer transmission using four antenna ports with transform precoding disabled.

| TPMI | W | | | | | | | |
|---|---|---|---|---|---|---|---|---|
| index | (ordered from left to right in increasing order of TPMI index) | | | | | | | |
| 0-7 | $\frac{1}{2} [ \begin{matrix}1 \\ 0 \\ 0 \\ 0\end{matrix} ]$ | $\frac{1}{2} [ \begin{matrix}0 \\ 1 \\ 0 \\ 0\end{matrix} ]$ | $\frac{1}{2} [ \begin{matrix}0 \\ 0 \\ 1 \\ 0\end{matrix} ]$ | $\frac{1}{2} [ \begin{matrix}0 \\ 0 \\ 0 \\ 1\end{matrix} ]$ | $\frac{1}{2} [ \begin{matrix}1 \\ 0 \\ 1 \\ 0\end{matrix} ]$ | $\frac{1}{2} [ \begin{matrix}1 \\ 0 \\ - 1 \\ 0\end{matrix} ]$ | $\frac{1}{2} [ \begin{matrix}1 \\ 0 \\ j \\ 0\end{matrix} ]$ | $\frac{1}{2} [ \begin{matrix}1 \\ 0 \\ - j \\ 0\end{matrix} ]$ |
| 8-15 | $\frac{1}{2} [ \begin{matrix}0 \\ 1 \\ 0 \\ 1\end{matrix} ]$ | $\frac{1}{2} [ \begin{matrix}0 \\ 1 \\ 0 \\ - 1\end{matrix} ]$ | $\frac{1}{2} [ \begin{matrix}0 \\ 1 \\ 0 \\ j\end{matrix} ]$ | $\frac{1}{2} [ \begin{matrix}0 \\ 1 \\ 0 \\ - j\end{matrix} ]$ | $\frac{1}{2} [ \begin{matrix}1 \\ 1 \\ 1 \\ 1\end{matrix} ]$ | $\frac{1}{2} [ \begin{matrix}1 \\ 1 \\ j \\ j\end{matrix} ]$ | $\frac{1}{2} [ \begin{matrix}1 \\ 1 \\ - 1 \\ - 1\end{matrix} ]$ | $\frac{1}{2} [ \begin{matrix}1 \\ 1 \\ - j \\ - j\end{matrix} ]$ |
| 16-23 | $\frac{1}{2} [ \begin{matrix}1 \\ j \\ 1 \\ j\end{matrix} ]$ | $\frac{1}{2} [ \begin{matrix}1 \\ j \\ j \\ - 1\end{matrix} ]$ | $\frac{1}{2} [ \begin{matrix}1 \\ j \\ - 1 \\ - j\end{matrix} ]$ | $\frac{1}{2} [ \begin{matrix}1 \\ j \\ - j \\ 1\end{matrix} ]$ | $\frac{1}{2} [ \begin{matrix}1 \\ - 1 \\ 1 \\ - 1\end{matrix} ]$ | $\frac{1}{2} [ \begin{matrix}1 \\ - 1 \\ j \\ - j\end{matrix} ]$ | $\frac{1}{2} [ \begin{matrix}1 \\ - 1 \\ - 1 \\ 1\end{matrix} ]$ | $\frac{1}{2} [ \begin{matrix}1 \\ - 1 \\ - j \\ j\end{matrix} ]$ |
| 24-27 | $\frac{1}{2} [ \begin{matrix}1 \\ - j \\ 1 \\ - j\end{matrix} ]$ | $\frac{1}{2} [ \begin{matrix}1 \\ - j \\ j \\ 1\end{matrix} ]$ | $\frac{1}{2} [ \begin{matrix}1 \\ - j \\ - 1 \\ j\end{matrix} ]$ | $\frac{1}{2} [ \begin{matrix}1 \\ - j \\ - j \\ - 1\end{matrix} ]$ | — | — | — | — |

TABLE 3
Precoding matrix W for two-layer transmission using
two antenna ports with transform precoding disabled.

| TPMI | W | | |
|---|---|---|---|
| index | (ordered from left to right in increasing order of TPMI index) | | |
| 0-2 | $\frac{1}{\sqrt{2}} [ \begin{matrix}1 & 0 \\ 0 & 1\end{matrix} ]$ | $\frac{1}{2} [ \begin{matrix}1 & 1 \\ 1 & - 1\end{matrix} ]$ | $\frac{1}{2} [ \begin{matrix}1 & 1 \\ j & - j\end{matrix} ]$ |

TABLE 4
Precoding matrix W for
two-layer transmission using four antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 \\ 0 & 1 \\ 0 & 0 \\ 0 & 0\end{matrix} ]$ | $\frac{1}{2} [ \begin{matrix}1 & 0 \\ 0 & 0 \\ 0 & 1 \\ 0 & 0\end{matrix} ]$ | $\frac{1}{2} [ \begin{matrix}1 & 0 \\ 0 & 0 \\ 0 & 0 \\ 0 & 1\end{matrix} ]$ | $\frac{1}{2} [ \begin{matrix}0 & 0 \\ 1 & 0 \\ 0 & 1 \\ 0 & 0\end{matrix} ]$ |
| 4-7 | $\frac{1}{2} [ \begin{matrix}0 & 0 \\ 1 & 0 \\ 0 & 0 \\ 0 & 1\end{matrix} ]$ | $\frac{1}{2} [ \begin{matrix}0 & 0 \\ 0 & 0 \\ 1 & 0 \\ 0 & 1\end{matrix} ]$ | $\frac{1}{2} [ \begin{matrix}1 & 0 \\ 0 & 1 \\ 1 & 0 \\ 0 & - j\end{matrix} ]$ | $\frac{1}{2} [ \begin{matrix}1 & 0 \\ 0 & 1 \\ 1 & 0 \\ 0 & j\end{matrix} ]$ |
| 8-11 | $\frac{1}{2} [ \begin{matrix}1 & 0 \\ 0 & 1 \\ - j & 0 \\ 0 & 1\end{matrix} ]$ | $\frac{1}{2} [ \begin{matrix}1 & 0 \\ 0 & 1 \\ - j & 0 \\ 0 & - 1\end{matrix} ]$ | $\frac{1}{2} [ \begin{matrix}1 & 0 \\ 0 & 1 \\ - 1 & 0 \\ 0 & - j\end{matrix} ]$ | $\frac{1}{2} [ \begin{matrix}1 & 0 \\ 0 & 1 \\ - 1 & 0 \\ 0 & j\end{matrix} ]$ |
| 12-15 | $\frac{1}{2} [ \begin{matrix}1 & 0 \\ 0 & 1 \\ j & 0 \\ 0 & 1\end{matrix} ]$ | $\frac{1}{2} [ \begin{matrix}1 & 0 \\ 0 & 1 \\ j & 0 \\ 0 & - 1\end{matrix} ]$ | $\frac{1}{2 \sqrt{2}} [ \begin{matrix}1 & 1 \\ 1 & 1 \\ 1 & - 1 \\ 1 & - 1\end{matrix} ]$ | $\frac{1}{2 \sqrt{2}} [ \begin{matrix}1 & 1 \\ 1 & 1 \\ j & - j \\ j & - j\end{matrix} ]$ |
| 16-19 | $\frac{1}{2 \sqrt{2}} [ \begin{matrix}1 & 1 \\ j & j \\ 1 & - 1 \\ j & - j\end{matrix} ]$ | $\frac{1}{2 \sqrt{2}} [ \begin{matrix}1 & 1 \\ j & j \\ j & - j \\ - 1 & 1\end{matrix} ]$ | $\frac{1}{2 \sqrt{2}} [ \begin{matrix}1 & 1 \\ - 1 & - 1 \\ 1 & - 1 \\ - 1 & 1\end{matrix} ]$ | $\frac{1}{2 \sqrt{2}} [ \begin{matrix}1 & 1 \\ - 1 & - 1 \\ j & - j \\ - j & j\end{matrix} ]$ |
| 20-21 | $\frac{1}{2 \sqrt{2}} [ \begin{matrix}1 & 1 \\ - j & - j \\ 1 & - 1 \\ - j & j\end{matrix} ]$ | $\frac{1}{2 \sqrt{2}} [ \begin{matrix}1 & 1 \\ - j & - j \\ j & - j \\ 1 & - 1\end{matrix} ]$ | — | — |

TABLE 5
Precoding matrix W for
three-layer transmission using four antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 \\ 0 & 1 & 0 \\ 0 & 0 & 1 \\ 0 & 0 & 0\end{matrix} ]$ | $\frac{1}{2} [ \begin{matrix}1 & 0 & 0 \\ 0 & 1 & 0 \\ 1 & 0 & 0 \\ 0 & 0 & 1\end{matrix} ]$ | $\frac{1}{2} [ \begin{matrix}1 & 0 & 0 \\ 0 & 1 & 0 \\ - 1 & 0 & 0 \\ 0 & 0 & 1\end{matrix} ]$ | $\frac{1}{2 \sqrt{3}} [ \begin{matrix}1 & 1 & 1 \\ 1 & - 1 & 1 \\ 1 & 1 & - 1 \\ 1 & - 1 & - 1\end{matrix} ]$ |
| 4-6 | $\frac{1}{2 \sqrt{3}} [ \begin{matrix}1 & 1 & 1 \\ 1 & - 1 & 1 \\ j & j & - j \\ j & - j & - j\end{matrix} ]$ | $\frac{1}{2 \sqrt{3}} [ \begin{matrix}1 & 1 & 1 \\ - 1 & 1 & - 1 \\ 1 & 1 & - 1 \\ - 1 & 1 & 1\end{matrix} ]$ | $\frac{1}{2 \sqrt{3}} [ \begin{matrix}1 & 1 & 1 \\ - 1 & 1 & - 1 \\ j & j & - j \\ - j & j & j\end{matrix} ]$ | — |

TABLE 6
Precoding matrix W for
four-layer transmission using four antenna ports with transform precoding disabled.

| TPMI | W | | | |
|---|---|---|---|---|
| index | (ordered from left to right in increasing order of TPMI index) | | | |
| 0-3 | $\frac{1}{2} [ \begin{matrix}1 & 0 & 0 & 0 \\ 0 & 1 & 0 & 0 \\ 0 & 0 & 1 & 0 \\ 0 & 0 & 0 & 1\end{matrix} ]$ | $\frac{1}{2 \sqrt{2}} [ \begin{matrix}1 & 1 & 0 & 0 \\ 0 & 0 & 1 & 1 \\ 1 & - 1 & 0 & 0 \\ 0 & 0 & 1 & - 1\end{matrix} ]$ | $\frac{1}{2 \sqrt{2}} [ \begin{matrix}1 & 1 & 0 & 0 \\ 0 & 0 & 1 & 1 \\ j & - j & 0 & 0 \\ 0 & 0 & j & - j\end{matrix} ]$ | $\frac{1}{4} [ \begin{matrix}1 & 1 & 1 & 1 \\ 1 & - 1 & 1 & - 1 \\ 1 & 1 & - 1 & - 1 \\ 1 & - 1 & - 1 & 1\end{matrix} ]$ |
| 4 | $\frac{1}{4} [ \begin{matrix}1 & 1 & 1 & 1 \\ 1 & - 1 & 1 & - 1 \\ j & j & - j & - j \\ j & - j & - j & j\end{matrix} ]$ | — | — | — |

The subset of TPMI indices for the three coherence types are summarized in Table 7 and Table 8, where rank=r corresponds to (and is equivalent to) r layers.

TABLE 7
Total power of precoding matrix Wfor 2 antenna ports

| | Non-Coherent (NC) TPMIs | | Full-Coherent (FC) TPMIs | |
|---|---|---|---|---|
| Rank | TPMI indices | Total power | TPMI indices | Total power |
| 1 | 0-1 | ½ | 2-5 | 1 |
| 2 | 0 | 1 | 1-2 | 1 |

TABLE 8
Total power of precoding matrix W for 4 antenna ports

| | Non-Coherent | | Partial-Coherent | | Full-Coherent | |
|---|---|---|---|---|---|---|
| | (NC) TPMIs | | (PC) TPMIs | | (FC) TPMIs | |
| | TPMI | Total | TPMI | Total | TPMI | Total |
| Rank | indices | power | indices | power | indices | power |
| 1 | 0-3 | ¼ | 4-11 | ½ | 12-27 | 1 |
| 2 | 0-5 | ½ | 6-13 | 1 | 14-21 | 1 |
| 3 | 0 | ¾ | 1-2 | 1 | 3-6 | 1 |
| 4 | 0 | 1 | 1-2 | 1 | 3-4 | 1 |

The corresponding supported codebookSubsets are summarized in Table 9 and Table 10.

TABLE 9
TPMI indices for codebookSubsets for 2 antenna ports

| Rank | Non-Coherent | fullAndPartialAndNonCoherent |
|---|---|---|
| 1 | 0-1 | 0-5 |
| 2 | 0 | 0-2 |

TABLE 10
TPMI indices for codebookSubsets for 4 antenna ports

| Rank | Non-Coherent | partialAndNonCoherent | fullAndPartialAndNonCoherent |
|---|---|---|---|
| 1 | 0-3 | 0-11 | 0-27 |
| 2 | 0-5 | 0-13 | 0-21 |
| 3 | 0 | 0-2 | 0-6 |
| 4 | 0 | 0-2 | 0-4 |

The term ‘antenna panel’ refers to a group of antenna ports or a group of antenna elements or a subset of antenna ports associated with a resource (e.g., SRS resource, CSI-RS resource, SSB block).

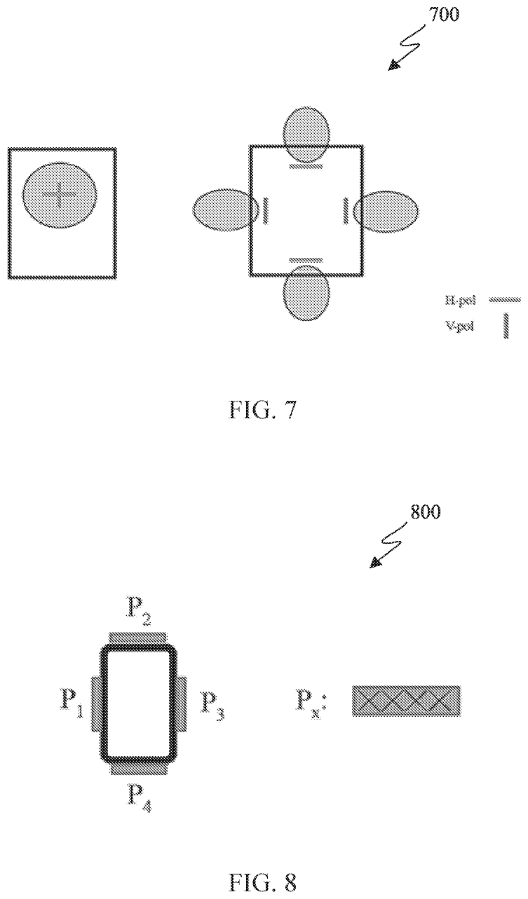

FIG. 7 illustrates an example antenna panel 700 according to embodiments of the present disclosure. The embodiment of the antenna panel 700 illustrated in FIG. 7 is for illustration only. FIG. 7 does not limit the scope of this disclosure to any particular implementation of the antenna panel.

FIG. 8 illustrates another example antenna panel 800 according to embodiments of the present disclosure. The embodiment of the antenna panel 800 illustrated in FIG. 8 is for illustration only. FIG. 8 does not limit the scope of this disclosure to any particular implementation of the antenna panel.

Two examples are shown in FIG. 7. The first example has a single panel comprising a dual-polarized (i.e., two) antennae/ports, and the second example has four panels each comprising a single antenna/ports (pointing in four different directions). Another example is shown in FIG. 8 wherein there are four antenna panels (on opposite sides), each comprising four dual-polarized antennae/ports.

For a UE equipped with multiple antenna panels, the UE can be configured with the following reporting to facilitate panel selection (1 out of multiple panel selection) or simultaneous (UL) transmission from multiple panels.
The UE can report a correspondence between a CSI-RS or SSB resource index and a UE capability value (or value set). This report can be via a beam/CSI report. Also, this reporting can correspond to an index or indicator or identifier (ID).
The UE capability value (or value set) belongs to a list of UE capability values (or value sets). The list can be reported via UE capability reporting.

A few examples of the UE capability value are as follows.
V₁: The UE capability value corresponds to a maximum supported number of SRS ports. In one example, the candidate values include {1,2,4} or {1,2,3,4}, or {1,2,4,6}, or {1,2,4,8}, or {1,2, . . . , N}, where N is the total (max) number of SRS ports at the UE (or the UE can support).
V₂: The UE capability value corresponds to a maximum number of layers or rank value. In one example, the candidate values include {1, . . . , L}, where L is the total (max) number of layers that the UE can support.
V₃: The UE capability value corresponds to a coherence type. In one example, the candidate values include {NC, PC, FC}.
V₄: The UE capability value corresponds to one or multiple TPMIs or a TPMI group. In one example, the candidate values include the TPMI indices from the Rel. 15 NR UL codebooks for N=2 and 4 ports, or an UL codebook for N>4 (e.g., N=6 or 8).

The capability value can convey an information about UE antenna panels. For example, for a UE with 2 panels each with 2 SRS ports, the capability value=2 SRS ports can indicate one panel, and the capability value=4 SRS ports can indicate two panels.

In one example, a UE capability value set comprises a pair (Vᵢ_{₁}, Vᵢ_{₂}), where (i₁, i₂)∈{(1,2), (1,3), (1,4), (2,3), (2,4), (3,4)} and Vᵢ is according to one of the examples above.

In one example, a UE capability value set comprises a tuple of N values (Vᵢ_{₁}, . . . , Vᵢ_{_{N}}), where each of i₁, . . . , i_{N}∈{1, . . . ,4} and Vᵢ is according to one of the examples above. Here N≥2.

In one example, for a UE equipped with multiple panels, a panel entity can also correspond to (or associated with or indicated via) at least one of the following quantities/entities.
In one example, a panel corresponds to a panel ID.
In one example, a panel corresponds to a resource ID (e.g., SRS resource ID, CSI-RS resource ID, SSB resource ID).
In one example, a panel corresponds to a resource set ID (e.g., SRS resource set ID, CSI-RS resource set ID, SSB resource set ID).
In one example, a panel corresponds to a max supported number of SRS ports (indicated/reported by the UE, e.g., via beam report), as described above in V₁.
In one example, a panel corresponds to a max supported number of layers (indicated/reported by the UE, e.g., via beam report), as described above in V₂.
In one example, a panel corresponds to a coherence type (indicated/reported by the UE, e.g., via beam report), as described above in V₃.
In one example, a panel corresponds to a TPMI (indicated/reported by the UE, e.g., via beam report), as described above in V₄.
In one example, a panel corresponds to a pair (Vᵢ_{₁}, Vᵢ_{₂}), as described above.
In one example, a panel corresponds to a tuple (Vᵢ_{₁}, . . . , Vᵢ_{_{N}}), as described above.

In the present disclosure, simultaneous multi-panel UL transmission from a UE with multiple antenna panels to a single TRP (sTRP) or multiple TRPs (mTRP) is considered. In particular, the following aspects have been discussed.
UL precoding indication for UL (PUSCH) transmission, based on Rel.15 UL codebooks or new UL codebooks,
the total number of layers is up to four across all panels
total number of codewords is up to two across all panels, and
considering single DCI and multi-DCI based multi-TRP operation.

In Rel.17 PUSCH transmission (e.g., PUSCH repetition, cf. Section 6.1.2.1, REF9) to multiple (e.g., up to 2 TRPs) is supported via the following components in specification.
The UE can be configured with 2 SRS resource sets (e.g., 1 per TRP), e.g., via srs-ResourceSetToAddModList or srs-ResourceSetToAddModListDCI-0-2 with higher layer parameter usage in SRS-ResourceSet set to ‘codebook’ or ‘nonCodebook’. The configured SRS resource sets are subject to the following restrictions:
   The same number of SRS resources can be configured in each set.
   The same number SRS ports can be configured in each SRS resource across all sets.

A summary of the supported components is provided in Table 11.

TABLE 11

| Components | New DCI fields | Purpose |
|---|---|---|
| Multiple SRS | SRS resource set indicator | Dynamic switch between |
| sets | | sTRP and mTRP |
| 2 SRIs | Second SRI (1st SRI = | DCI indicates 1 or 2 |
| | Rel.15/16 based) | SRIs |
| 2 TPMIs | Second TPMI (1st TPMI = | DCI indicates 1 or 2 |
| | Rel.15/16 based) | TPMIs |
| Restriction: | Second SRI or second TPMI | PUSCH repetition |
| same number | corresponds to the same | |
| of layers | number of layers as first SRI | |
| | or first TPMI, respectively | |

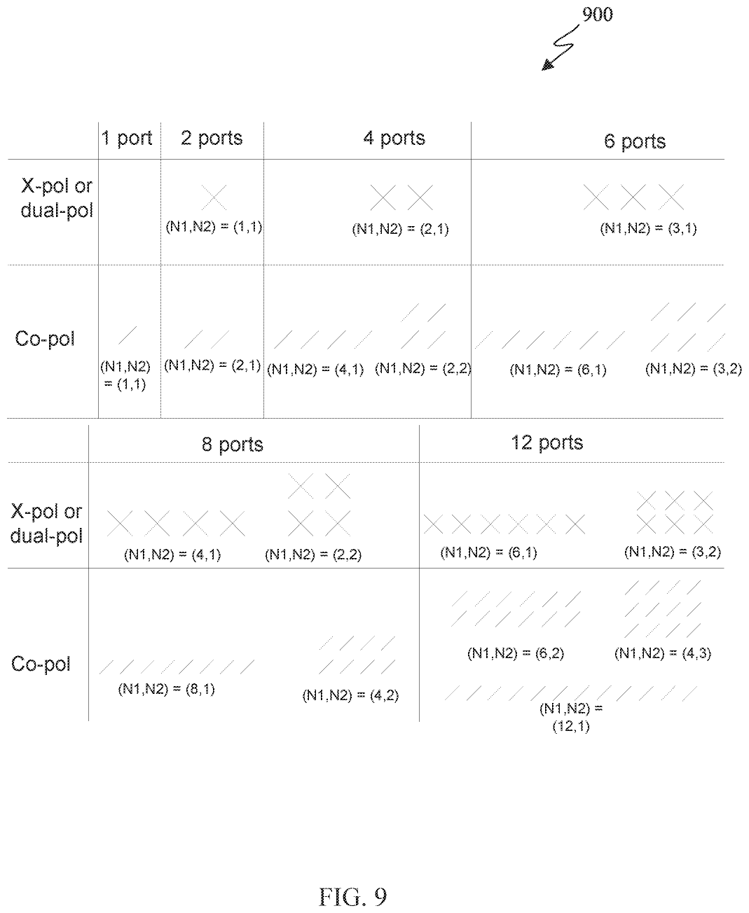

In an antenna panel, let N₁ and N₂ be the number of antenna ports with the same polarization in the first and second dimensions, respectively. For 2D antenna port layouts, we have N₁>1, N₂>1, and for 1D antenna port layouts, we either have N₁>1 and N₂=1 or N₂>1 and N₁=1. In the rest of the present disclosure, 1D antenna port layouts with N₁>1 and N₂=1 is considered. The present disclosure, however, is applicable to the other 1D port layouts with N₂>1 and N₁=1. Also, in the rest of the present disclosure, we assume that N₁>N₂. The present disclosure, however, is applicable to the case when N₁<N₂, and the embodiments for N₁>N₂ applies to the case N₁<N₂ by swapping/switching (N₁, N₂) with (N₂, N₁). For a (single-polarized) co-polarized antenna port layout, the total number of antenna ports is N₁N₂ and for a dual-polarized antenna port layout, the total number of antenna ports is 2N₁N₂. An illustration of antenna port layouts for {1, 2, 4, 6, 8, 12} antenna ports at UE is shown in FIG. 9.

FIG. 9 illustrates an example antenna port layout 900 according to embodiments of the present disclosure. The embodiment of the antenna port layout 900 illustrated in FIG. 9 is for illustration only. FIG. 9 does not limit the scope of this disclosure to any particular implementation of the antenna port layout.

Let s denote the number of antenna polarizations (or groups of antenna ports with the same polarization). Then, for co-polarized antenna ports, s=1, and for dual- or cross (X)-polarized antenna ports s=2. So, the total number of antenna ports P=sN₁N₂. In one example, the antenna ports at the UE refers to SRS antenna ports (either in one SRS resource or across multiple SRS resources).

We assume all antenna ports of the UE belonging to a single antenna panel are co-located, for example, at one plane, side, or edge of the UE. For a UE equipped with multiple antenna panels, any two panels can be separated and located at different locations such as sides or edges or corners or on front or back sides. Each antenna panel can be assumed to have a structure as shown in FIG. 9.

In one embodiment, a UE equipped with X>1 antenna panels (e.g., X=2 or 3 or 4) is configured with (via RRC) or granted (via UL-DCI, e.g., format 0_1 or 0_2 in NR specification) an UL transmission e.g., PUSCH transmission and/or PUCCH transmission, where the UL transmission can be transmitted simultaneously from multiple panels (STxMP) or a single panel (SP) or a combination of STxMP and SP (as described later).

In one scheme, whether the UL transmission corresponds to STxMP or SP or a combination of STxMP and SP is determined by the UE and is not known to the NW/gNB (i.e., transparent scheme).

In one scheme, whether the UL transmission corresponds to STxMP or SP or a combination of STxMP and SP is determined by the UE and an information about this is provided/reported to the NW/gNB (e.g., via UE capability reporting and/or beam/CSI reporting).

In one scheme, whether the UL transmission corresponds to STxMP or SP or a combination of STxMP and SP is determined by the NW/gNB and an information about this is provided/configured/indicated to the UE (e.g., via UE capability reporting and/or beam/CSI reporting).

When the configured or granted UL transmission is transmitted to a single TRP (sTRP), e.g., when one PUSCH is configured or granted for transmission, at least one of the following sTRP UL transmission schemes can be used/configured.

In one scheme, the UE is configured or granted with an UL transmission based on a TPMI codebook (e.g., codebook based transmission can be configured when the higher layer parameter xConfig in pusch-Config is set to ‘codebook’).

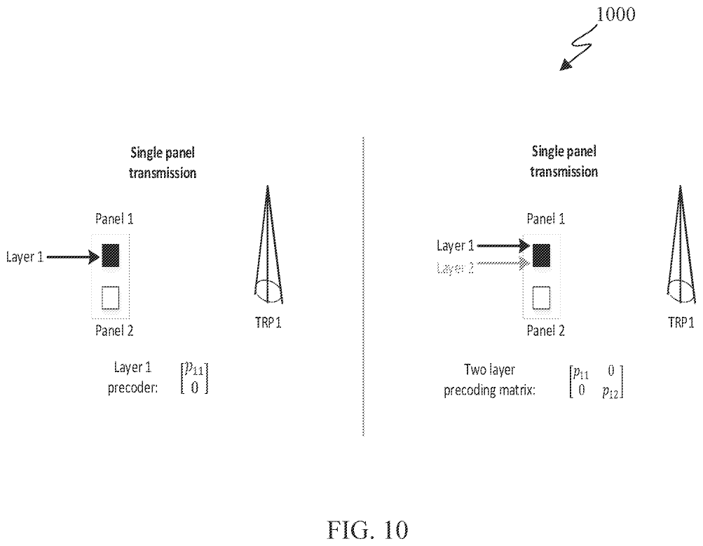

FIG. 10 illustrates an uplink transmission scheme 1000 according to embodiments of the present disclosure. The embodiment of the uplink transmission scheme 1000 illustrated in FIG. 10 is for illustration only. FIG. 10 does not limit the scope of this disclosure to any particular implementation of the uplink transmission scheme.

In one example, the UL transmission corresponds to a SP transmission, and the transmission scheme is based on the codebook based UL transmission e.g., as in Rel.15 NR specification, as described in section 6.1.1.1 of [REF9]. An information regarding the selection of a single panel (out of multiple UE panels) can be provided either by the UE (e.g., via a report) or configured/indicated by the NW/gNB (e.g., via RRC or MAC CE or UL-DCI). The one panel for the UL transmission is determined based on the information. In one example, the information about the panel selection is indicated via a new indicator (e.g., panel ID indicator) or SRI (indicating a SRS resource that is associated with the selected panel) or SRS resource set indicator (indicating a SRS resource set that is associated with the selected panel) or a capability index included in the beam/CSI report (e.g., the report including CRI/SSBRI, L1-RSRP/L1-SINR, and the capability index). When the UL transmission includes multiple layers, then all layers are transmitted from the selected panel. An example is illustrated in FIG. 10, wherein the selected panel is panel 1, and one UL layer (left) or two layers (right) are transmitted from panel 1.

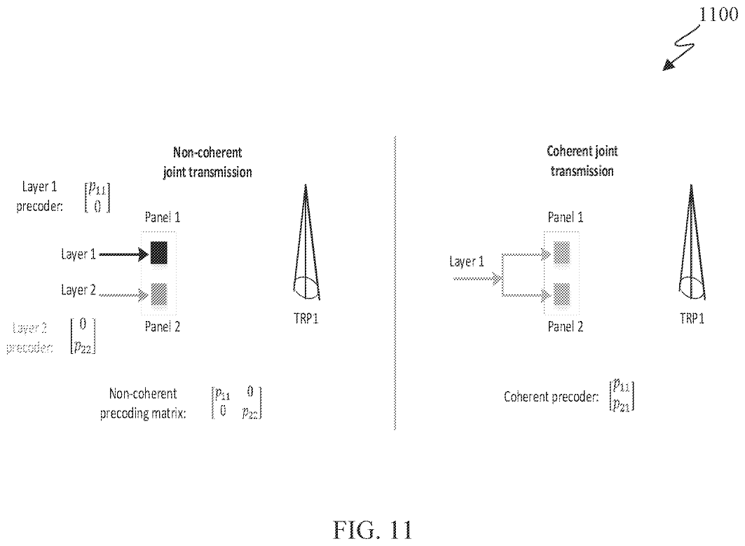

FIG. 11 illustrates an uplink transmission scheme 1100 according to embodiments of the present disclosure. The embodiment of the uplink transmission scheme 1100 illustrated in FIG. 11 is for illustration only. FIG. 11 does not limit the scope of this disclosure to any particular implementation of the uplink transmission scheme.

In one example, the UL transmission corresponds to a STxMP transmission. At least one of the following STxMP schemes is used/configured.
In one example, the STxMP transmission corresponds to a non-coherent joint transmission (NCJT) across panels wherein a layer of UL transmission can only be transmitted from one panel. An example is illustrated in FIG. 10, wherein there are two panels, and one UL layer is transmitted from each panel. In this example, the codebook for TPMI indication can be one of the following.
   In one example, the codebook includes non-coherent (NC) precoding matrices. For example, the codebook includes NC TPMI indices as summarized in Table 7 and Table 8.
   In one example, the codebook includes partial-coherent (PC) precoding matrices. For example, the codebook includes PC TPMI indices as summarized in Table 8. For PC precoding matrices, a pair of antenna ports maps to an antenna panel.
   In one example, the codebook includes both NC and PC precoding matrices. For example, the codebook includes PC and NC TPMI indices as summarized in Table 7 and Table 8.
In one example, the STxMP transmission corresponds to a coherent joint transmission (CJT) across panels wherein a layer of UL transmission can only be transmitted from multiple panels. An example is illustrated in FIG. 11, wherein there are two panels, and an UL layer is transmitted using both panels. In this example, the codebook for TPMI indication can be one of the following.
   In one example, the codebook includes full-coherent (FC) precoding matrices. For example, the codebook includes FC TPMI indices as summarized in Table 7 and Table 8.
   In one example, the codebook includes full-coherent (FC) and PC precoding matrices. For example, the codebook includes FC and PC TPMI indices as summarized in Table 7 and Table 8.
   In one example, the codebook includes full-coherent (FC), PC, and NC precoding matrices. For example, the codebook includes FC, PC, and NC TPMI indices as summarized in Table 7 and Table 8.
In one example, the STxMP transmission corresponds to NCJT or CJT or a combination of NCJT and CJT e.g., based on a condition or configuration or reporting (from the UE).
   In one example, the STxMP transmission corresponds to CJT for lower layers and NCJT for higher layers or vice versa (i.e., NCJT for lower layers and CJT for higher layers). In one example, the lower layers correspond to l₁ . . . lₓ and the higher layer correspond to lₓ₊₁ . . . lᵥ, where v is the transmission rank (number of layers) and x is fixed (e.g., 1 or 2) or configured (e.g., RRC or MAC CE or DCI) or reported by the UE (e.g., via UE capability reporting and/or beam/CSI reporting). In one example, x can't take a value x=0 or v (implying a combination of NCJT and CJT). In one example, x can only take a value x=0 or v (implying one of NCJT and CJT). In one example, x can only take a value x=0 or v or a value in {1, . . . , } (implying one of NCJT and CJT or a one of NCJT and CJT).
   In one example, the STxMP transmission corresponds to CJT for lower rank values and NCJT for higher rank values or vice versa (i.e., NCJT for lower ranks and CJT for higher ranks). In one example, the lower rank values correspond to r₁ . . . r_{y} and the higher rank values correspond to r_{y}+₁ . . . r_{L}, where L is the max transmission rank (number of layers) and y is fixed (e.g., 2) or configured (e.g., RRC or MAC CE or DCI) or reported by the UE (e.g., via UE capability reporting and/or beam/CSI reporting). In one example, y can't take a value y=0 or L (implying a combination of NCJT and CJT). In one example, y can only take a value y=0 or L (implying one of NCJT and CJT). In one example, y can only take a value y=0 or L or a value in {1, . . . , } (implying one of NCJT and CJT or a one of NCJT and CJT).
   In one example, the STxMP transmission corresponds to CJT for lower number of antenna ports and NCJT for higher number of antenna ports or vice versa (i.e., NCJT for higher number of antenna ports and CJT for lower number of antenna ports). In one example, the lower number of antenna ports correspond to p₁ . . . p_{z} and the higher number of antenna ports correspond to p_{z+1} . . . p_{K}, where K is the max number of antenna ports and z is fixed (e.g., 2) or configured (e.g., RRC or MAC CE or DCI) or reported by the UE (e.g., via UE capability reporting and/or beam/CSI reporting). In one example, z can't take a value z=0 or K (implying a combination of NCJT and CJT). In one example, z can only take a value z=0 or K (implying one of NCJT and CJT). In one example, z can only take a value z=0 or K or a value in {1, . . . , } (implying one of NCJT and CJT or a one of NCJT and CJT).
   In one example, the STxMP transmission corresponds to CJT for lower number of antenna panels (e.g., 2 panels) and NCJT for higher number of antenna panels (e.g., 4 panels) or vice versa (i.e., NCJT for higher number of antenna panels and CJT for lower number of antenna panels). In one example, the lower number of antenna panels correspond to a₁ . . . aₜ and the higher number of antenna panels correspond to aₜ₊₁ . . . a_{X}, where X is the max number of antenna panels and t is fixed (e.g., 2) or configured (e.g., RRC or MAC CE or DCI) or reported by the UE (e.g., via UE capability reporting and/or beam/CSI reporting). In one example, t can't take a value t=0 or X (implying a combination of NCJT and CJT). In one example, t can only take a value t=0 or X (implying one of NCJT and CJT). In one example, t can only take a value t=0 or X or a value in {1, . . . , }(implying one of NCJT and CJT or a one of NCJT and CJT).

In one example, the CJT transmission to a sTRP can be configured for a single frequency network (SFN) based UL transmission. In one example, the CJT transmission to a sTRP can be configured for a spatial multiplexing based UL transmission.

In one example, the UL transmission corresponds to SP or STxMP or a combination of SP and STxMP, where STxMP can be NCJT or CJT or a combination of NCJT and CJT (as described above). This can be based on a condition or configuration or reporting (from the UE).
In one example, the UL transmission corresponds to SP or STxMP or a combination of SP and STxMP across layers or based on number of layers (v).
   When v=1, the UL transmission corresponds to SP or CJT.
   When v=2, the UL transmission corresponds to at least one of the following:
      SP for all layers
      NCJT for all layers
      CJT for all layers
      SP for layer 1 and CJT for layer 2
      CJT for layer 1 and SP for layer 2
   When v>2, the UL transmission corresponds to at least one of the following:
      SP for all layers
      NCJT for all layers
      CJT for all layers
      SP for lower layers (corresponding to l₁ . . . lₓ) and CJT for higher layers (corresponding to lₓ₊₁ . . . lᵥ), or vice versa, where x is determined as described above.
      SP for lower layers (corresponding to l₁ . . . lₓ) and NCJT for higher layers (corresponding to lₓ₊₁ . . . lᵥ), or vice versa, where x is determined as described above.
      NCJT for lower layers (corresponding to l₁ . . . lₓ) and CJT for higher layers (corresponding to lₓ₊₁ . . . lᵥ), or vice versa, where x is determined as described above.
      NCJT for lower layers (corresponding to l₁ . . . lₓ) and SP for higher layers (corresponding to lₓ₊₁ . . . lᵥ), or vice versa, where x is determined as described above.
      CJT for lower layers (corresponding to l₁ . . . lₓ) and NCJT for higher layers (corresponding to lₓ₊₁ . . . lᵥ), or vice versa, where x is determined as described above.
      CJT for lower layers (corresponding to l₁ . . . lₓ) and SP for higher layers (corresponding to lₓ₊₁ . . . lᵥ), or vice versa, where x is determined as described above.
      SP for a first set of layers (corresponding to l₁ . . . lₓ_{₁}), NCJT for a second set of layers (corresponding to lₓ_{₁}₊₁ . . . lₓ_{₂}), and CJT for a third set of layers (corresponding to lₓ_{₂}₊₁ . . . lᵥ), where x₁, x₂ is similar to the description on x as described above.
      SP for a first set of layers (corresponding to l₁ . . . lₓ_{₁}), CJT for a second set of layers (corresponding to lₓ_{₁}₊₁ . . . lₓ_{₂}), and NCJT for a third set of layers (corresponding to lₓ_{₂}₊₁ . . . lᵥ), where x₁, x₂ is similar to the description on x as described above.
      NCJT for a first set of layers (corresponding to l₁ . . . lₓ_{₁}), SP for a second set of layers (corresponding to lₓ_{₁}₊₁ . . . lₓ_{₂}), and CJT for a third set of layers (corresponding to lₓ_{₂}₊₁ . . . lᵥ), where x₁, x₂ is similar to the description on x as described above.
      NCJT for a first set of layers (corresponding to l₁ . . . lₓ_{₁}), CJT for a second set of layers (corresponding to lₓ_{₁}₊₁ . . . lₓ_{₂}), and SP for a third set of layers (corresponding to lₓ_{₂}₊₁ . . . lᵥ), where x₁, x₂ is similar to the description on x as described above.
      CJT for a first set of layers (corresponding to l₁ . . . lₓ_{₁}), SP for a second set of layers (corresponding to lₓ_{₁}₊₁ . . . lₓ_{₂}), and NCJT for a third set of layers (corresponding to lₓ_{₂}₊₁ . . . lᵥ), where x₁, x₂ is similar to the description on x as described above.
      CJT for a first set of layers (corresponding to l₁ . . . lₓ_{₁}), NCJT for a second set of layers (corresponding to lₓ_{₁}₊₁ . . . lₓ_{₂}), and SP for a third set of layers (corresponding to lₓ_{₂}₊₁ . . . lᵥ), where x₁, x₂ is similar to the description on x as described above.
In one example, the UL transmission corresponds to SP or STxMP or a combination of SP and STxMP across rank values or based on max rank value (L).
   When L=1, the UL transmission corresponds to SP or CJT.
   When L=2, the UL transmission corresponds to at least one of the following:
      SP for all ranks
      NCJT for all ranks
      CJT for all ranks
      SP for rank 1 and CJT for rank 2
      CJT for rank 1 and SP for rank 2
      SP for rank 1 and NCJT for rank 2
      CJT for rank 1 and NCJT for rank 2
   When L>2, the UL transmission corresponds to at least one of the following:
      SP for all ranks
      NCJT for all ranks
      CJT for all ranks
      SP for lower ranks and CJT for higher ranks, or vice versa, as described above.
      SP for lower ranks and NCJT for higher ranks, or vice versa, as described above.
      NCJT for lower ranks and CJT for higher ranks, or vice versa, as described above.
      NCJT for lower ranks and SP for higher ranks, or vice versa, as described above.
      CJT for lower ranks and NMCJT for higher ranks, or vice versa, as described above.
      CJT for lower ranks and SP for higher ranks, or vice versa, as described above.
      SP for a first set of ranks, NCJT for a second set of ranks, and CJT for a third set of ranks, as described above.
      SP for a first set of ranks, CJT for a second set of ranks, and NCJT for a third set of ranks, as described above.
      CJT for a first set of ranks, NCJT for a second set of ranks, and SP for a third set of ranks, as described above.
      CJT for a first set of ranks, SP for a second set of ranks, and NCJT for a third set of ranks, as described above.
      NCJT for a first set of ranks, CJT for a second set of ranks, and SP for a third set of ranks, as described above.
      NCJT for a first set of ranks, SP for a second set of ranks, and CJT for a third set of ranks, as described above.
In one example, the UL transmission corresponds to SP or STxMP or a combination of SP and STxMP based on (max) number of antenna ports (K). Let pᵢ denote a number of antenna ports, where pᵢ≤K. In one example, pᵢ∈{2,4,6,8,12,16}. Also, pᵢ<pⱼ for i<j.
   When K=p₁, the UL transmission corresponds to SP or CJT or NCJT.
   When K E {p₁, p₂}, the UL transmission corresponds to at least one of the following:
      SP for all number of antenna ports
      NCJT for all number of antenna ports
      CJT for all number of antenna ports
      SP for p₁ and CJT for p₂
      CJT for p₁ and SP for p₂
      SP for p₁ and NCJT for p₂
      NCJT for p₁ and SP for p₂
      CJT for p₁ and NCJT p₂
      NCJT for p₁ and CJT p₂
   When K∈{p₁, p₂, p₃, . . . }, the UL transmission corresponds to at least one of the following:
      SP for all number of antenna ports
      NCJT for all number of antenna ports
      CJT for all number of antenna ports
      SP for lower number of antenna ports and CJT for higher number of antenna ports, or vice versa, as described above.
      SP for lower number of antenna ports and NCJT for higher number of antenna ports, or vice versa, as described above.
      NCJT for lower number of antenna ports and CJT for higher number of antenna ports, or vice versa, as described above.
      NCJT for lower number of antenna ports and SP for higher number of antenna ports, or vice versa, as described above.
      CJT for lower number of antenna ports and NMCJT for higher number of antenna ports, or vice versa, as described above.
      CJT for lower number of antenna ports and SP for higher number of antenna ports, or vice versa, as described above.
      SP for a first set of number of antenna ports, NCJT for a second set of number of antenna ports, and CJT for a third set of number of antenna ports, as described above.
      SP for a first set of number of antenna ports, CJT for a second set of number of antenna ports, and NCJT for a third set of number of antenna ports, as described above.
      CJT for a first set of number of antenna ports, NCJT for a second set of number of antenna ports, and SP for a third set of number of antenna ports, as described above.
      CJT for a first set of number of antenna ports, SP for a second set of number of antenna ports, and NCJT for a third set of number of antenna ports, as described above.
      NCJT for a first set of number of antenna ports, CJT for a second set of number of antenna ports, and SP for a third set of number of antenna ports, as described above.
      NCJT for a first set of number of antenna ports, SP for a second set of number of antenna ports, and CJT for a third set of number of antenna ports, as described above.
In one example, the UL transmission corresponds to SP or STxMP or a combination of SP and STxMP based on (max) number of antenna panels (X). Let aᵢ denote a number of antenna panels, where aₜ; X. In one example, a E {2,4,6,8,12,16}. Also, aᵢ<aⱼ for i<j.
   When X=a₁, the UL transmission corresponds to SP or CJT or NCJT.
   When X∈{a₁, a₂}, the UL transmission corresponds to at least one of the following:
      SP for all number of antenna panels
      NCJT for all number of antenna panels
      CJT for all number of antenna panels
      SP for rank 1 and CJT for rank 2
      CJT for rank 1 and SP for rank 2
      SP for rank 1 and NCJT for rank 2
      CJT for rank 1 and NCJT for rank 2
   When X∈{a₁, a₂, a₃, . . . }, the UL transmission corresponds to at least one of the following:
      SP for all number of antenna panels
      NCJT for all number of antenna panels
      CJT for all number of antenna panels
      SP for lower number of antenna panels and CJT for higher number of antenna panels, or vice versa, as described above.
      SP for lower number of antenna panels and NCJT for higher number of antenna panels, or vice versa, as described above.
      NCJT for lower number of antenna panels and CJT for higher number of antenna panels, or vice versa, as described above.
      NCJT for lower number of antenna panels and SP for higher number of antenna panels, or vice versa, as described above.
      CJT for lower number of antenna panels and NMCJT for higher number of antenna panels, or vice versa, as described above.
      CJT for lower number of antenna panels and SP for higher number of antenna panels, or vice versa, as described above.
      SP for a first set of number of antenna panels, NCJT for a second set of number of antenna panels, and CJT for a third set of number of antenna panels, as described above.
      SP for a first set of number of antenna panels, CJT for a second set of number of antenna panels, and NCJT for a third set of number of antenna panels, as described above.
      CJT for a first set of number of antenna panels, NCJT for a second set of number of antenna panels, and SP for a third set of number of antenna panels, as described above.
      CJT for a first set of number of antenna panels, SP for a second set of number of antenna panels, and NCJT for a third set of number of antenna panels, as described above.
      NCJT for a first set of number of antenna panels, CJT for a second set of number of antenna panels, and SP for a third set of number of antenna panels, as described above.
      NCJT for a first set of number of antenna panels, SP for a second set of number of antenna panels, and CJT for a third set of number of antenna panels, as described above.

In one scheme, the UE is configured or granted with an UL transmission based on a non-codebook based scheme (e.g., non-codebook based transmission can be configured when the higher layer parameter xConfig in pusch-Config is set to ‘nonCodebook’).

In one example, the UL transmission corresponds to a SP transmission, and the transmission scheme is based on the non-codebook based UL transmission, e.g., as in Rel.15 NR specification, as described in section 6.1.1.2 of [REF9]. An information regarding the selection of a single panel (out of multiple UE panels) can be provided either by the UE (e.g., via a report) or configured/indicated by the NW/gNB (e.g., via RRC or MAC CE or UL-DCI). The one panel for the UL transmission is determined based on the information. In one example, the information about the panel selection is indicated via a new indicator (e.g., panel ID indicator) or SRI (indicating a SRS resource that is associated with the selected panel) or SRS resource set indicator (indicating a SRS resource set that is associated with the selected panel) or a capability index included in the beam/CSI report (e.g., the report including CRI/SSBRI, L1-RSRP/L1-SINR, and the capability index). When the UL transmission includes multiple layers, then all layers are transmitted from the selected panel. An example is illustrated in FIG. 10.

In one example, the UL transmission corresponds to a STxMP transmission and the transmission scheme is based on the non-codebook based UL transmission, e.g., as in Rel.15 NR specification, as described in section 6.1.1.2 of [REF9], except that the transmission is from multiple panels. In this case, SRI may indicate one joint SRI indicating SRS resources associated with all panels, or multiple SRIs (one SRI per panel), each SRI indicating a SRS resource or multiple SRS resources for a panel, or multiple sets of SRIs (one set per panel), each set including one SRI indicating a SRS resource or multiple SRIs indicating multiple SRS resources for a panel.

In one scheme, the UE is configured or granted with an UL transmission for a TRP, as described above, wherein the transmission is codebook-based from one panel (or a set of panels) and non-codebook-based from another panel (or another set of panels). Such a transmission can be configured by higher layer (or granted via UL-DCI). In one example, when a panel is associated with one port or one-port SRS resource, and the transmission from this panel is SP or NCJT, the transmission from this panel is non-codebook-based. Likewise, when a panel is associated with multiple ports or more than one-port SRS resource, the transmission from this panel is codebook-based. The UE is indicated with a TPMI (and SRI if multiple SRS resources are associated with) for the panel (or the set of panels) for the codebook-based, and a SRI for the another panel (or the another set of panels) for non-codebook-based.

In one example, the UE can be configured to switch the UL transmission scheme via higher layer or MAC CE or dynamic (DCI) signaling. In one example, when DCI is used, a SRS resource indicator (SRI) can be used to indicate the UL transmission from one or multiple panels depending on the UL transmission scheme as described above. The SRS resource indicator can indicate one SRS resource (e.g., associated with a panel) or multiple SRS resources (e.g., associated with a panel). In one example, when DCI is used, a SRS resource set indicator can be used to indicate the UL transmission from one or multiple panels depending on the UL transmission scheme as described above. The SRS resource set indicator can indicate one SRS resource set (e.g., associated with a panel) or multiple SRS resource sets (e.g., associated with a panel).

When the configured or granted UL transmission is transmitted to multiple TRPs (mTRP), e.g., when multiple PUSCHs (e.g., 2 or 3 or 4 PUSCHs) are configured or granted for transmission, at least one of the following mTRP UL transmission schemes can be used/configured. In one example, a mTRP transmission scheme corresponds to multiple PUSCHs configured/granted for mTRPs (e.g., one PUSCH per TRP). In one example, the multiple PUSCHs are configured/granted for PUSCH repetition, as described in Section 6.1.2.1 [REF9], the repetition can be in time domain (across slots), and/or frequency domain (across PRBs). In one example, the multiple PUSCHs are configured/granted for PUSCH transmission across time and/or frequency resources that can be completely overlapping (the same for all PUSCHs) or partially overlapping or non-overlapping. For PUSCH, the UL grant of such UL transmission can be joint via a single DCI (sDCI), e.g., an UL DCI, or via a multiple DCIs (mDCI), e.g., one UL-DCI per TRP. In one example, the UL grant of such UL transmission can be joint via a single DCI (sDCI), e.g., an UL DCI for a TRP (or a set of TRPs), or via a multiple DCIs (mDCI), e.g., one UL-DCI per TRP, for another TRP (another set of TRPs).

In one scheme, the UE is configured or granted with an UL transmission for multiple TRPs based on a TPMI codebook (e.g., codebook based transmission can be configured when the higher layer parameter xConfig in pusch-Config is set to ‘codebook’).

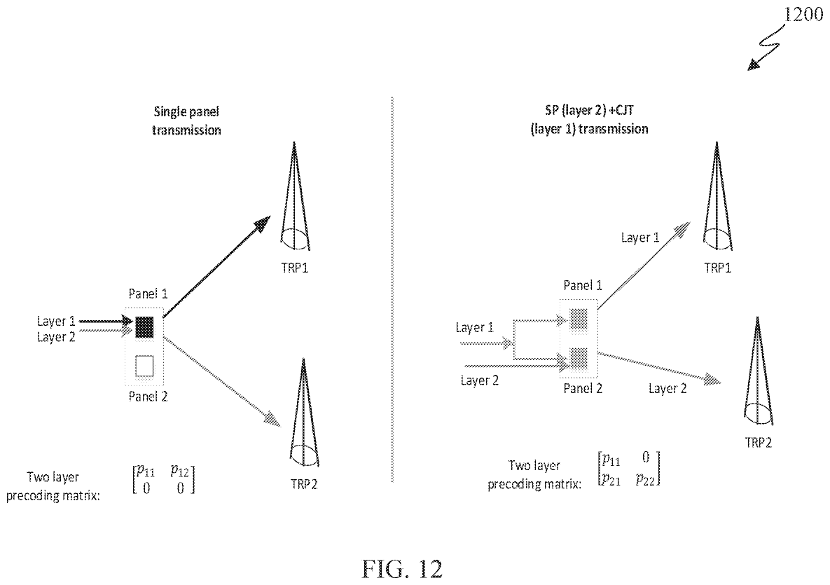

FIG. 12 illustrates an uplink transmission scheme 1200 according to embodiments of the present disclosure. The embodiment of the uplink transmission scheme 1200 illustrated in FIG. 12 is for illustration only. FIG. 12 does not limit the scope of this disclosure to any particular implementation of the uplink transmission scheme.

In one example, the UL transmission corresponds to a SP transmission, and the transmission scheme is based on the codebook based UL transmission, e.g., as in Rel.17 NR specification, as described in section 6.1.1.1 and 6.1.2.1 of [REF9]. An information regarding the selection of a single panel (out of multiple UE panels) can be provided either by the UE (e.g., via a report) or configured/indicated by the NW/gNB (e.g., via RRC or MAC CE or UL-DCI). The one panel for the UL transmission is determined based on the information. In one example, the information about the panel selection is indicated via a new indicator (e.g., panel ID indicator) or SRI (indicating a SRS resource that is associated with the selected panel) or SRS resource set indicator (indicating a SRS resource set that is associated with the selected panel) or a capability index included in the beam/CSI report (e.g., the report including CRI/SSBRI, L1-RSRP/L1-SINR, and the capability index). When the UL transmission includes multiple layers, then all layers are transmitted from the selected panel. An example is illustrated in FIG. 10, wherein the selected panel is panel 1 for 2 TRPs (left), and the selected panel is panel 1 for TRP 2 and both panels are selected (CJT) for TRP 1.

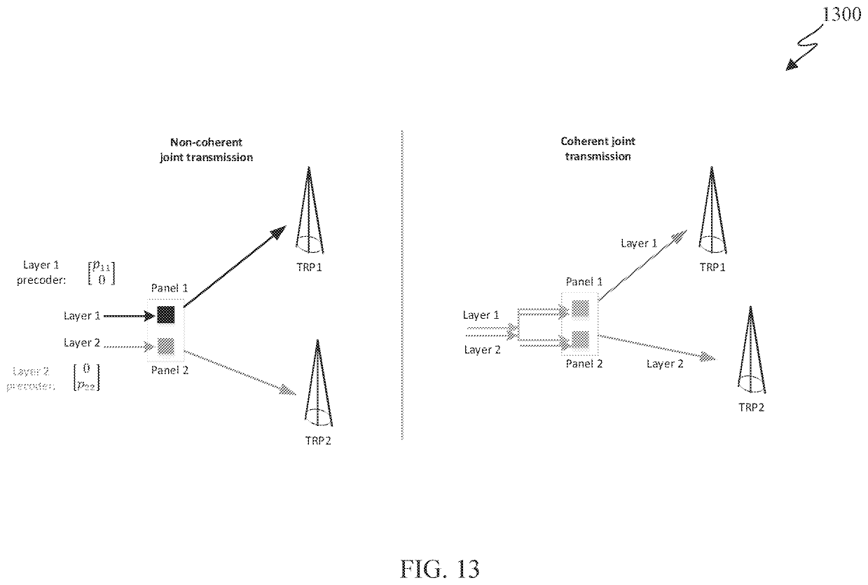

FIG. 13 illustrates an uplink transmission scheme 1300 according to embodiments of the present disclosure. The embodiment of the uplink transmission scheme 1300 illustrated in FIG. 13 is for illustration only. FIG. 13 does not limit the scope of this disclosure to any particular implementation of the uplink transmission scheme.

In one example, the UL transmission corresponds to a STxMP transmission. Two examples are illustrated in FIG. 13. At least one of the following STxMP schemes is used/configured.
In one example, the UL transmission corresponds to NCJT from multiple panels to multiple TRPs (e.g., one panel to one TRP), wherein an UL transmission (e.g., PUSCH) for a TRP can only be transmitted from one panel.
   In one example, when there are two TRPs, there are two TPMIs (TPMI1 and TPMI2). Each of the two TPMIs can be indicated from a codebook comprising either only NC precoders, or only PC precoders, or both NC and PC precoders, as described above.
In one example, the UL transmission corresponds to NCJT from multiple panels to one TRP (or set of TRPs) or CJT from multiple panels to another TRP (or another set of TRPs) or a combination of NCJT and CJT. The total of X panels can be divided into two (X₁ and X₂) such that X₁+X₂=X or X₁+X₂≤X, and X₁ panels are used for NCJT to one TRP (or set of TRPs), and X₂ panels are used for CJT to another TRP (or another set of TRPs).
   In one example, when there are two TRPs, there are two TPMIs (TPMI1 and TPMI2), where TPMI1 and TPMI2 are indicated from a codebook comprising the following types of precoders.
      TPMI1: codebook comprising only NC, only PC, or both NC and PC precoders, as described above.
      TPMI2: codebook comprising only FC, or (FC and PC), or (FC, PC, and NC) precoders, as described above.
   In one example, the STxMP transmission corresponds to CJT for lower layers and NCJT for higher layers or vice versa (i.e., NCJT for lower layers and CJT for higher layers), where the layers can be across TRPs or per TRP. In one example, the lower layers correspond to l₁ . . . lₓ and the higher layer correspond to lₓ₊₁ . . . lᵥ, where v is the transmission rank (number of layers) and x is fixed (e.g., 1 or 2) or configured (e.g., RRC or MAC CE or DCI) or reported by the UE (e.g., via UE capability reporting and/or beam/CSI reporting). In one example, x can't take a value x=0 or v (implying a combination of NCJT and CJT). In one example, x can only take a value x=0 or v (implying one of NCJT and CJT). In one example, x can only take a value x=0 or v or a value in {1, . . . , } (implying one of NCJT and CJT or a one of NCJT and CJT).
   In one example, the STxMP transmission corresponds to CJT for lower rank values and NCJT for higher rank values or vice versa (i.e., NCJT for lower ranks and CJT for higher ranks) where the rank values can be across TRPs or per TRP. In one example, the lower rank values correspond to r₁ . . . r_{y} and the higher rank values correspond to r_{y+1} . . . r_{L}, where L is the max transmission rank (number of layers) and y is fixed (e.g., 2) or configured (e.g., RRC or MAC CE or DCI) or reported by the UE (e.g., via UE capability reporting and/or beam/CSI reporting). In one example, y can't take a value y=0 or L (implying a combination of NCJT and CJT). In one example, y can only take a value y=0 or L (implying one of NCJT and CJT). In one example, y can only take a value y=0 or L or a value in {1, . . . , } (implying one of NCJT and CJT or a one of NCJT and CJT).
   In one example, the STxMP transmission corresponds to CJT for lower number of antenna ports and NCJT for higher number of antenna ports or vice versa (i.e., NCJT for higher number of antenna ports and CJT for lower number of antenna ports) where the number of antenna ports can be across TRPs or per TRP. In one example, the lower number of antenna ports correspond to p₁ . . . p_{z} and the higher number of antenna ports correspond to p_{z+1} . . . p_{K}, where K is the max number of antenna ports and z is fixed (e.g., 2) or configured (e.g., RRC or MAC CE or DCI) or reported by the UE (e.g., via UE capability reporting and/or beam/CSI reporting). In one example, z can't take a value z=0 or K (implying a combination of NCJT and CJT). In one example, z can only take a value z=0 or K (implying one of NCJT and CJT). In one example, z can only take a value z=0 or K or a value in {1, . . . , } (implying one of NCJT and CJT or a one of NCJT and CJT).
   In one example, the STxMP transmission corresponds to CJT for lower number of antenna panels (e.g., 2 panels) and NCJT for higher number of antenna panels (e.g., 4 panels) or vice versa (i.e., NCJT for higher number of antenna panels and CJT for lower number of antenna panels) where the number of antenna panels can be across TRPs or per TRP. In one example, the lower number of antenna panels correspond to a₁ . . . aₜ and the higher number of antenna panels correspond to aₜ₊₁ . . . a_{X}, where X is the max number of antenna panels and t is fixed (e.g., 2) or configured (e.g., RRC or MAC CE or DCI) or reported by the UE (e.g., via UE capability reporting and/or beam/CSI reporting). In one example, t can't take a value t=0 or X (implying a combination of NCJT and CJT). In one example, t can only take a value t=0 or X (implying one of NCJT and CJT). In one example, t can only take a value t=0 or X or a value in {1, . . . , } (implying one of NCJT and CJT or a one of NCJT and CJT).
In one example, the UL transmission corresponds to CJT from multiple panels to multiple TRPs (e.g., multiple panels to one TRP), wherein an UL transmission (e.g., PUSCH) for a TRP can only be transmitted from multiple panels. This can be based on a condition or configuration or reporting (from the UE).
   In one example, when there are two TRPs, there are two TPMIs (TPMI1 and TPMI2). Each of the two TPMIs can be indicated from a codebook comprising either only FC precoders, or (FC and PC), or (FC, PC, and NC) precoders, as described in example B.1.2.

In one example, the UL transmission corresponds to SP or STxMP or a combination of SP and STxMP, where STxMP can be NCJT or CJT or a combination of NCJT and CJT (as described above). This can be based on a condition or configuration or reporting (from the UE).
In one example, the UL transmission corresponds to SP or STxMP or a combination of SP and STxMP across layers or based on number of layers (v), where the layers can be across TRPs or per TRP.
   When v=1, the UL transmission corresponds to SP or CJT.
   When v=2, the UL transmission corresponds to aₜ least one of the following:
      SP for all layers
      NCJT for all layers
      CJT for all layers
      SP for layer 1 and CJT for layer 2
      CJT for layer 1 and SP for layer 2
   When v>2, the UL transmission corresponds to at least one of the following:
      SP for all layers
      NCJT for all layers
      CJT for all layers
      SP for lower layers (corresponding to l₁ . . . lₓ) and CJT for higher layers (corresponding to lₓ₊₁ . . . lᵥ), or vice versa, where x is determined as described above.
      SP for lower layers (corresponding to l₁ . . . lₓ) and NCJT for higher layers (corresponding to lₓ₊₁ . . . lᵥ), or vice versa, where x is determined as described above.
      NCJT for lower layers (corresponding to l₁ . . . lₓ) and CJT for higher layers (corresponding to lₓ₊₁ . . . lᵥ), or vice versa, where x is determined as described above.
      NCJT for lower layers (corresponding to l₁ . . . lₓ) and SP for higher layers (corresponding to lₓ₊₁ . . . lᵥ), or vice versa, where x is determined as described above.
      CJT for lower layers (corresponding to l₁ . . . lₓ) and NCJT for higher layers (corresponding to lₓ₊₁ . . . lᵥ), or vice versa, where x is determined as described above.
      CJT for lower layers (corresponding to l₁ . . . lₓ) and SP for higher layers (corresponding to lₓ₊₁ . . . lᵥ), or vice versa, where x is determined as described above.
      SP for a first set of layers (corresponding to l₁ . . . lₓ_{₁}), NCJT for a second set of layers (corresponding to lₓ_{₁}₊₁ . . . lₓ_{₂}), and CJT for a third set of layers (corresponding to lₓ_{₂}₊₁ . . . lᵥ), where x₁, x₂ is similar to the description on x as described above.
      SP for a first set of layers (corresponding to l₁ . . . lₓ_{₁}), CJT for a second set of layers (corresponding to lₓ_{₁}₊₁ . . . lₓ_{₂}), and NCJT for a third set of layers (corresponding to lₓ_{₂}₊₁ . . . lᵥ), where x₁, x₂ is similar to the description on x as described above.
      NCJT for a first set of layers (corresponding to l₁ . . . lₓ_{₁}), SP for a second set of layers (corresponding to lₓ_{₁}₊₁ . . . lₓ_{₂}), and CJT for a third set of layers (corresponding to lₓ_{₂}₊₁ . . . lᵥ), where x₁, x₂ is similar to the description on x as described above.
      NCJT for a first set of layers (corresponding to l₁ . . . lₓ_{₁}), CJT for a second set of layers (corresponding to lₓ_{₁}₊₁ . . . lₓ_{₂}), and SP for a third set of layers (corresponding to lₓ_{₂}₊₁ . . . lᵥ), where x₁, x₂ is similar to the description on x as described above.
      CJT for a first set of layers (corresponding to l₁ . . . lₓ_{₁}), SP for a second set of layers (corresponding to lₓ₊₁l₁ . . . lₓ_{₂}), and NCJT for a third set of layers (corresponding to lₓ_{₂}₊₁ . . . lᵥ), where x₁, x₂ is similar to the description on x as described above.
      CJT for a first set of layers (corresponding to l₁ . . . lₓ_{₁}), NCJT for a second set of layers (corresponding to lₓ1+l₁ . . . lₓ_{₂}), and SP for a third set of layers (corresponding to lₓ_{₂}₊₁ . . . lᵥ), where x₁, x₂ is similar to the description on x as described above.
In one example, the UL transmission corresponds to SP or STxMP or a combination of SP and STxMP across rank values or based on max rank value (L), where the rank can be across TRPs or per TRP.
   When L=1, the UL transmission corresponds to SP or CJT.
   When L=2, the UL transmission corresponds to at least one of the following:
      SP for all ranks
      NCJT for all ranks
      CJT for all ranks
      SP for rank 1 and CJT for rank 2
      CJT for rank 1 and SP for rank 2
      SP for rank 1 and NCJT for rank 2
      CJT for rank 1 and NCJT for rank 2
   When L>2, the UL transmission corresponds to at least one of the following:
      SP for all ranks
      NCJT for all ranks
      CJT for all ranks
      SP for lower ranks and CJT for higher ranks, or vice versa, as described above.
      SP for lower ranks and NCJT for higher ranks, or vice versa, as described above.
      NCJT for lower ranks and CJT for higher ranks, or vice versa, as described above.
      NCJT for lower ranks and SP for higher ranks, or vice versa, as described above.
      CJT for lower ranks and NMCJT for higher ranks, or vice versa, as described above.
      CJT for lower ranks and SP for higher ranks, or vice versa, as described above.
      SP for a first set of ranks, NCJT for a second set of ranks, and CJT for a third set of ranks, as described above.
      SP for a first set of ranks, CJT for a second set of ranks, and NCJT for a third set of ranks, as described above.
      CJT for a first set of ranks, NCJT for a second set of ranks, and SP for a third set of ranks, as described above.
      CJT for a first set of ranks, SP for a second set of ranks, and NCJT for a third set of ranks, as described above.
      NCJT for a first set of ranks, CJT for a second set of ranks, and SP for a third set of ranks, as described above.
      NCJT for a first set of ranks, SP for a second set of ranks, and CJT for a third set of ranks, as described above.
In one example, the UL transmission corresponds to SP or STxMP or a combination of SP and STxMP based on (max) number of antenna ports (K). Let p₁ denote a number of antenna ports, where pᵢ≤K. In one example, pᵢ∈{2,4,6,8,12,16}. Also, pᵢ<pⱼ for i<j, where the number of antenna ports can be across TRPs or per TRP.
   When K=pᵢ, the UL transmission corresponds to SP or CJT or NCJT.
   When K E {p₁, p₂}, the UL transmission corresponds to aₜ least one of the following:
      SP for all number of antenna ports
      NCJT for all number of antenna ports
      CJT for all number of antenna ports
      SP for p₁ and CJT for p₂
      CJT for p₁ and SP for p₂
      SP for p₁ and NCJT for p₂
      NCJT for p₁ and SP for p₂
      CJT for p₁ and NCJT p₂
      NCJT for p₁ and CJT p₂
   When K∈{p₁, p₂, p₃, . . . }, the UL transmission corresponds to at least one of the following:
      SP for all number of antenna ports
      NCJT for all number of antenna ports
      CJT for all number of antenna ports
      SP for lower number of antenna ports and CJT for higher number of antenna ports, or vice versa, as described above.
      SP for lower number of antenna ports and NCJT for higher number of antenna ports, or vice versa, as described above.
      NCJT for lower number of antenna ports and CJT for higher number of antenna ports, or vice versa, as described above.
      NCJT for lower number of antenna ports and SP for higher number of antenna ports, or vice versa, as described above.
      CJT for lower number of antenna ports and NMCJT for higher number of antenna ports, or vice versa, as described above.
      CJT for lower number of antenna ports and SP for higher number of antenna ports, or vice versa, as described above.
      SP for a first set of number of antenna ports, NCJT for a second set of number of antenna ports, and CJT for a third set of number of antenna ports, as described above.
      SP for a first set of number of antenna ports, CJT for a second set of number of antenna ports, and NCJT for a third set of number of antenna ports, as described above.
      CJT for a first set of number of antenna ports, NCJT for a second set of number of antenna ports, and SP for a third set of number of antenna ports, as described above.
      CJT for a first set of number of antenna ports, SP for a second set of number of antenna ports, and NCJT for a third set of number of antenna ports, as described above.
      NCJT for a first set of number of antenna ports, CJT for a second set of number of antenna ports, and SP for a third set of number of antenna ports, as described above.
      NCJT for a first set of number of antenna ports, SP for a second set of number of antenna ports, and CJT for a third set of number of antenna ports, as described above.
In one example, the UL transmission corresponds to SP or STxMP or a combination of SP and STxMP based on (max) number of antenna panels (X). Let aᵢ denote a number of antenna panels, where aₜ X. In one example, a E {2,4,6,8,12,16}. Also, aᵢ<aⱼ for i<j, where the number of antenna panels can be across TRPs or per TRP.
   When X=a₁, the UL transmission corresponds to SP or CJT or NCJT.
   When X∈{a₁, a₂}, the UL transmission corresponds to at least one of the following:
      SP for all number of antenna panels
      NCJT for all number of antenna panels
      CJT for all number of antenna panels
      SP for rank 1 and CJT for rank 2
      CJT for rank 1 and SP for rank 2
      SP for rank 1 and NCJT for rank 2
      CJT for rank 1 and NCJT for rank 2
   When X∈{a₁, a₂, a₃, . . . }, the UL transmission corresponds to aₜ least one of the following:
      SP for all number of antenna panels
      NCJT for all number of antenna panels
      CJT for all number of antenna panels
      SP for lower number of antenna panels and CJT for higher number of antenna panels, or vice versa, as described above.
      SP for lower number of antenna panels and NCJT for higher number of antenna panels, or vice versa, as described above.
      NCJT for lower number of antenna panels and CJT for higher number of antenna panels, or vice versa, as described above.
      NCJT for lower number of antenna panels and SP for higher number of antenna panels, or vice versa, as described above.
      CJT for lower number of antenna panels and NMCJT for higher number of antenna panels, or vice versa, as described above.
      CJT for lower number of antenna panels and SP for higher number of antenna panels, or vice versa, as described above.
      SP for a first set of number of antenna panels, NCJT for a second set of number of antenna panels, and CJT for a third set of number of antenna panels, as described above.
      SP for a first set of number of antenna panels, CJT for a second set of number of antenna panels, and NCJT for a third set of number of antenna panels, as described above.
      CJT for a first set of number of antenna panels, NCJT for a second set of number of antenna panels, and SP for a third set of number of antenna panels, as described above.
      CJT for a first set of number of antenna panels, SP for a second set of number of antenna panels, and NCJT for a third set of number of antenna panels, as described above.
      NCJT for a first set of number of antenna panels, CJT for a second set of number of antenna panels, and SP for a third set of number of antenna panels, as described above.
      NCJT for a first set of number of antenna panels, SP for a second set of number of antenna panels, and CJT for a third set of number of antenna panels, as described above.

In one scheme, the UE is configured or granted with an UL transmission for mTRPs based on a non-codebook based scheme (e.g., non-codebook based transmission can be configured when the higher layer parameter xConfig in pusch-Config is set to ‘nonCodebook’).

In one example, the UL transmission corresponds to a SP transmission, and the transmission scheme is based on the non-codebook based UL transmission, e.g., as in Rel.17 NR specification, as described in section 6.1.1.1 and 6.1.2.1 of [REF9]. An information regarding the selection of a single panel (out of multiple UE panels) can be provided either by the UE (e.g., via a report) or configured/indicated by the NW/gNB (e.g., via RRC or MAC CE or UL-DCI). The one panel for the UL transmission is determined based on the information. In one example, the information about the panel selection is indicated via a new indicator (e.g., panel ID indicator) or SRI (indicating a SRS resource that is associated with the selected panel) or SRS resource set indicator (indicating a SRS resource set that is associated with the selected panel). or a capability index included in the beam/CSI report (e.g., the report including CRI/SSBRI, L1-RSRP/L1-SINR, and the capability index). When the UL transmission includes multiple layers, then all layers are transmitted from the selected panel.

In one example, the UL transmission corresponds to a STxMP transmission and the transmission scheme is based on the non-codebook based UL transmission, e.g., as in Rel.17 NR specification, as described in section 6.1.1.2 and 6.1.2.1 of [REF9], except that the transmission is from multiple panels. In one example, SRI may indicate one joint SRI across panels and TRPs, i.e., indicating SRS resources associated with all panels and TRPs or multiple SRIs (one SRI per panel), each SRI indicating a SRS resource or multiple SRS resources for a panel and is associated with (or is across) all TRPs, or multiple sets of SRIs (one set per panel), each set including one SRI indicating a SRS resource or multiple SRIs indicating multiple SRS resources for a panel and is associated with (or is across) all TRPs. In one example, SRI may indicate one joint SRI per TRP (number of SRIs=number of TRPs), each indicating SRS resources associated with all panels or multiple SRIs per TRP (one SRI per panel per TRP), each SRI indicating a SRS resource or multiple SRS resources for a panel, or multiple sets of SRIs (one set per panel per TRP), each set including one SRI indicating a SRS resource or multiple SRIs indicating multiple SRS resources for a panel.

In one scheme, the UE is configured or granted with an UL transmission for mTRPs, as described above, e.g., when multiple PUSCHs (e.g., 2 or 3 or 4 PUSCHs) are configured or granted for transmission, wherein the transmission is codebook-based to one TRP (or a set of TRPs) and non-codebook-based to another TRP (or another set of TRPs). For example, one panel (or a set of panels) can perform codebook-based transmission to one TRP (or a set of TRPs) and another panel (or another set of panels) can perform non-codebook-based transmission for another TRP (or another set of TRPs). Such a transmission can be configured by higher layer (or granted via UL-DCI).

In one example, the UE can be configured to switch the UL transmission scheme via higher layer or MAC CE or dynamic (DCI) signaling. Also, the UE can be configured to switch between sTRP and mTRP transmission schemes via higher layer or MAC CE or dynamic (DCI) signaling. In one example, when DCI is used, a SRS resource set indicator can be used to indicate the UL transmission from one or multiple panels depending on the UL transmission scheme as described above. The SRS resource set indicator can indicate one SRS resource set (e.g., associated with a panel and/or TRP) or multiple SRS resource sets (e.g., associated with a panel and/or TRP).

In one scheme, the UE is configured or granted with an UL transmission for mTRPs, as described above, e.g., when multiple PUSCHs (e.g., 2 or 3 or 4 PUSCHs) are configured or granted for transmission, wherein the transmission is codebook-based to one TRP (or a set of TRPs) from one panel (or a set of panels), and non-codebook-based to another TRP (or another set of TRPs) from another panel (or another set of panels). For example, one panel (or a set of panels) can perform codebook-based transmission to one TRP (or a set of TRPs) and another panel (or another set of panels) can perform non-codebook-based transmission for another TRP (or another set of TRPs). Such a transmission can be configured by higher layer (or granted via UL-DCI).

In one embodiment, a UE is configured with a codebook (CB) based UL transmission from multiple antenna panels (e.g., from 2 panels) to one (sTRP) or multiple TRPs (e.g., 2 TRPs), as described earlier in this disclosure. For each TRP, at least one of the following examples is used/configured regarding the SRI and TPMI.
In one example, the UE is configured (e.g., configured grant case) or indicated (via UL-DCI) with 1 SRI and 1 TPMI. The one SRI indicates either one SRS resource (associated with one panel or multiple panels) or multiple SRS resources (each associated with each panel). Likewise, the one TPMI indicates either one precoder (associated with one panel or multiple panels) or multiple precoders (each associated with each panel).
In one example, the UE is configured (e.g., configured grant case) or indicated (via UL-DCI) with 1 SRI and multiple TPMIs. The one SRI indicates either one SRS resource (associated with one panel or multiple panels) or multiple SRS resources (each associated with each panel). The multiple TPMIs are associated with multiple panels (e.g., one per panel).
In one example, the UE is configured (e.g., configured grant case) or indicated (via UL-DCI) with multiple SRIs and 1 TPMI. The multiple SRIs are associated with multiple panels (e.g., one per panel). The one TPMI indicates either one precoder (associated with one panel or multiple panels) or multiple precoders (each associated with each panel).

In one embodiment, a UE is configured with a non-codebook (NCB) based UL transmission from multiple antenna panels (e.g., from 2 panels) to one (sTRP) or multiple TRPs (e.g., 2 TRPs), as described earlier in this disclosure. For each TRP, at least one of the following examples is used/configured regarding the SRI and TPMI.
In one example, the UE is configured (e.g., configured grant case) or indicated (via UL-DCI) with 1 SRS resource set that is partitioned into multiple parts/subsets (one for each panel).
In one example, the UE is configured (e.g., configured grant case) or indicated (via UL-DCI) with multiple SRS resource sets, one for each panel.

In one embodiment, a UE is configured with an UL transmission from multiple antenna panels (e.g., from 2 panels) to one (sTRP) or multiple TRPs (e.g., 2 TRPs), as described earlier in this disclosure, where the precoder and/or transmission type (SP or STxMP) of the UL transmission is determined based on a coherence type. For example, when the coherence type is partial-coherence or non-coherence, the UL transmission corresponds to a SP transmission, and when the coherence type is full-coherence, the UL transmission corresponds to a STxMP transmission. The information about the coherence type can be reported by the UE (e.g., via beam, or CSI report). Alternatively, the information can be provided/indicated/configured by the NW/gNB (e.g., via higher layer, or MAC CE, or DCI based signaling). In one example, the information about the coherence type is provided by the UE via UE capability signaling. The UL codebook for TPMI indication is configured subject to (or depending on) the information about the coherence type.

In one embodiment, a UE is configured with an UL transmission from multiple antenna panels (e.g., from 2 panels) to one (sTRP) or multiple TRPs (e.g., 2 TRPs), as described earlier in this disclosure, where the precoder and/or transmission type (SP or STxMP) of the UL transmission is determined based on TPMI type/group. For example, when the TPMI type/group indicates (corresponds to) precoding matrices that comprise at least one zero-row, the UL transmission corresponds to a SP transmission, and when the TPMI type/group indicates precoding matrices that comprise all non-zero rows, the UL transmission corresponds to a STxMP transmission. The information about the TPMI type/group can be reported by the UE (e.g., via beam, or CSI report). Alternatively, the information can be provided/indicated/configured by the NW/gNB (e.g., via higher layer, or MAC CE, or DCI based signaling). In one example, the information about the TPMI type is provided by the UE via UE capability signaling. The UL codebook for TPMI indication is configured subject to (or depending on) the information about the TPMI type/group.

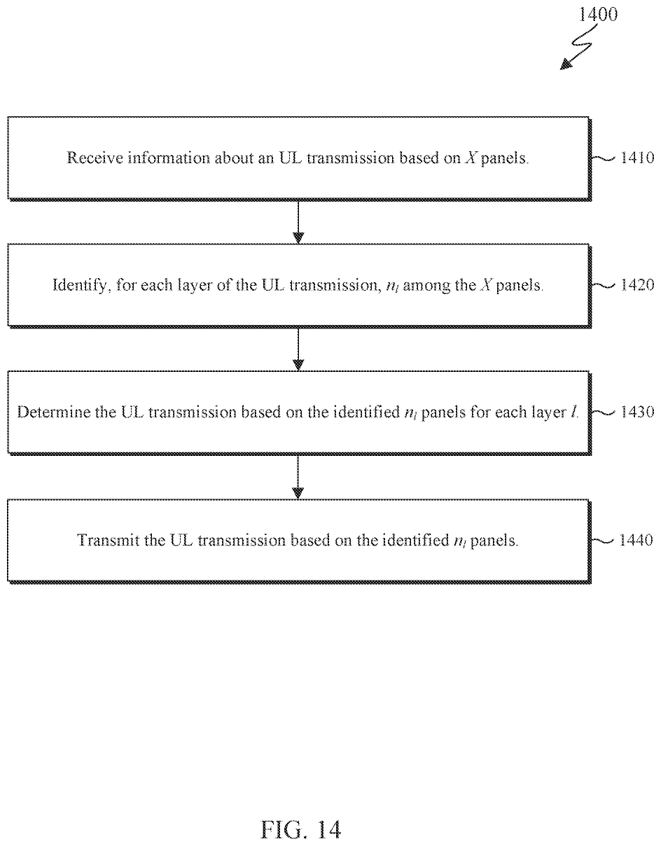

FIG. 14 illustrates an example method 1400 for uplink transmission in a wireless communication system according to embodiments of the present disclosure. The steps of the method 1400 of FIG. 14 can be performed by any of the UEs 111-116 of FIG. 1, such as the UE 116 of FIG. 3. The method 1400 is for illustration only and other embodiments can be used without departing from the scope of the present disclosure.

The method 1400 begins with the UE receiving information about an UL transmission based on X panels (step 1410). For example, in step 1410, each panel of the X panels includes a group of antenna ports where X>1. The UE then identifies, based on the information, for each layer l of the UL transmission, nₗ panels among the X panels (step 1420). For example, in step 1420, nₗ≤X, l=1, . . . , v and v is a number of layers of the UL transmission. The UE then determines the UL transmission based on the identified nₗ panels for each layer l (step 1430). The UE then transmits the UL transmission based on the identified nₗ panels (step 1440). For example, in step 1440, the UL transmission corresponds to one of a SP transmission from one of the X panels, a STxMP, or a combination of the SP and STxMP, where a set S₁ of the X panels is used for the SP transmission and a set S₂ of the X panels is used for the STxMP.

In any one or more of the embodiments above, the STxMP corresponds to one of: when nₗ=1, a NCJT where one panel of the multiple panels is used for a layer l of the UL transmission, when nₗ>1, a CJT where aₜ least two of the multiple panels are used for a layer l of the UL transmission, or a combination of the NCJT and the CJT, where a set T₁ of the X panels is used for the NCJT and a set T₂ of the X panels is used for the CJT.

In any one or more of the embodiments above, the information corresponds to a configuration via RRC signaling or an UL grant via DCI.

In any one or more of the embodiments above, the UL transmission includes (i) at least one PUCCH transmission or (ii) a combination of at least one PUSCH transmission and at least one PUCCH transmission.

In any one or more of the embodiments above, the UL transmission includes one of a single PUSCH including all of the v layers, a multiple PUSCHs, each including at least one of the v layers, or a combination of the single PUSCH and the multiple PUSCHs, where a set U₁ of the X panels is used for the single PUSCH and a set U₂ of the X panels is used for the multiple PUSCHs. In any one or more of the embodiments above, the multiple PUSCHs or the combination of the single PUSCH and the multiple PUSCHs is granted via DCI.

In any one or more of the embodiments above, the UL transmission corresponds to one of: a CB-based transmission, wherein a panel among the X panels includes a group of antenna ports associated with one or multiple SRS resources, each comprising multiple SRS ports, a NCB-based transmission, wherein a panel among the X panels includes a group of antenna ports associated with one or multiple SRS resources, each comprising one SRS port, or a combination of a CB-based transmission and a non-CB-based transmission, where a set V₁ of the X panels is used for the CB-based transmission and a set V₂ of the X panels is used for the NCB-based transmission. In any one or more of the embodiments above, for the CB-based transmission, the information includes: one or multiple TPMIs, or one or multiple TPMIs and one or multiple SRIs, for the NCB-based transmission, the information includes one or multiple SRIs, each of the one or multiple TPMIs indicates a precoding matrix from a codebook, and each of the one or multiple SRIs indicates: for the CB-based transmission, at least one SRS resource with multiple SRS ports, and for the NCB-based transmission, at least one SRS resource with one SRS port. In any one or more of the embodiments above, the codebook includes at least one of: FC precoding matrices comprising all non-zero entries, PC precoding matrices comprising at least two non-zero entries and remaining zero entries in each column, and NC precoding matrices comprising one non-zero entry and remaining zero entries.

In any one or more of the embodiments above, the UE further transmits UE capability information including an information for support of the UL transmission based on the X panels.

Any of the above variation embodiments can be utilized independently or in combination with at least one other variation embodiment.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) comprising:
a transceiver configured to receive information about an uplink (UL) transmission based on X panels, each panel of the X panels including a group of antenna ports, where X>1; and
a processor operably coupled to the transceiver, the processor, based on the information, configured to:
identify, for each layer l of the UL transmission, nₗ panels among the X panels, where nₗ≤X, l=1, . . . , v, and v is a number of layers of the UL transmission, and
determine the UL transmission based on the identified nₗ panels for each layer l, wherein the transceiver is further configured to transmit the UL transmission based on the identified nₗ panels for each layer l, and
wherein the UL transmission corresponds to one of:
a single panel (SP) transmission from one of the X panels,
a simultaneous transmission from multiple of the X panels (STxMP), or
a combination of the SP and STxMP, where a set S₁ of the X panels is used for the SP transmission and a set S₂ of the X panels is used for the STxMP.

2. The UE of claim 1, wherein the STxMP corresponds to one of:
when nₗ=1, a non-coherent joint transmission (NCJT) where one panel of the multiple panels is used for a layer l of the UL transmission,
when nₗ>1, a coherent joint transmission (CJT) where at least two of the multiple panels are used for a layer l of the UL transmission, or
a combination of the NCJT and the CJT, where a set T₁ of the X panels is used for the NCJT and a set T₂ of the X panels is used for the CJT.

3. The UE of claim 1, wherein the information corresponds to a configuration via radio resource control (RRC) signaling or an UL grant via downlink control information (DCI).

4. The UE of claim 1, wherein the UL transmission includes (i) at least one physical uplink control channel (PUCCH) transmission or (ii) a combination of at least one physical uplink shared channel (PUSCH) transmission and at least one PUCCH transmission.

5. The UE of claim 1, wherein the UL transmission includes one of:
a single physical uplink shared channel (PUSCH) including all of the v layers,
a multiple PUSCHs, each including at least one of the v layers, or
a combination of the single PUSCH and the multiple PUSCHs, where a set U₁ of the X panels is used for the single PUSCH and a set U₂ of the X panels is used for the multiple PUSCHs.

6. The UE of claim 5, wherein the multiple PUSCHs or the combination of the single PUSCH and the multiple PUSCHs is granted via downlink control information (DCI).

7. The UE of claim 1, wherein the UL transmission corresponds to one of:
a codebook (CB)-based transmission, wherein a panel among the X panels includes a group of antenna ports associated with one or multiple sounding reference signal (SRS) resources, each comprising multiple SRS ports,
a non-codebook (NCB)-based transmission, wherein a panel among the X panels includes a group of antenna ports associated with one or multiple SRS resources, each comprising one SRS port, or
a combination of a CB-based transmission and a non-CB-based transmission, where a set V₁ of the X panels is used for the CB-based transmission and a set V₂ of the X panels is used for the NCB-based transmission.

8. The UE of claim 7, wherein:
for the CB-based transmission, the information includes:
one or multiple transmit precoding matrix indicators (TPMIs), or
one or multiple TPMIs and one or multiple SRS resource indicators (SRIs), for the NCB-based transmission, the information includes one or multiple SRIs,
each of the one or multiple TPMIs indicates a precoding matrix from a codebook, and
each of the one or multiple SRIs indicates:
for the CB-based transmission, at least one SRS resource with multiple SRS ports, and
for the NCB-based transmission, at least one SRS resource with one SRS port.

9. The UE of claim 8, wherein the codebook includes at least one of:
full-coherent (FC) precoding matrices comprising all non-zero entries,
partial-coherent (PC) precoding matrices comprising at least two non-zero entries and remaining zero entries in each column, and
non-coherent (NC) precoding matrices comprising one non-zero entry and remaining zero entries.

10. The UE of claim 1, wherein the transceiver is further configured to transmit UE capability information including an information for support of the UL transmission based on the X panels.

11. A method for operating a user equipment (UE), the method comprising:
receiving information about an uplink (UL) transmission based on X panels, each panel of the X panels including a group of antenna ports, where X>1;
identifying, based on the information, for each layer l of the UL transmission, nₗ panels among the X panels, where nₗ≤X, l=1, . . . , v, and v is a number of layers of the UL transmission;
determining the UL transmission based on the identified nₗ panels for each layer l; and
transmitting the UL transmission based on the identified nₗ panels for each layer l,
wherein the UL transmission corresponds to one of:
a single panel (SP) transmission from one of the X panels,
a simultaneous transmission from multiple of the X panels (STxMP), or
a combination of the SP and STxMP, where a set S₁ of the X panels is used for the SP transmission and a set S₂ of the X panels is used for the STxMP.

12. The method of claim 11, wherein the STxMP corresponds to one of:
when nₗ=1, a non-coherent joint transmission (NCJT) where one panel of the multiple panels is used for a layer l of the UL transmission,
when nₗ>1, a coherent joint transmission (CJT) where at least two of the multiple panels are used for a layer l of the UL transmission, or
a combination of the NCJT and the CJT, where a set T₁ of the X panels is used for the NCJT and a set T₂ of the X panels is used for the CJT.

13. The method of claim 11, wherein the information corresponds to a configuration via radio resource control (RRC) signaling or an UL grant via downlink control information (DCI).

14. The method of claim 11, wherein the UL transmission includes (i) at least one physical uplink control channel (PUCCH) transmission or (ii) a combination of at least one physical uplink shared channel (PUSCH) transmission and at least one PUCCH transmission.

15. The method of claim 11, wherein the UL transmission includes one of:
a single physical uplink shared channel (PUSCH) including all of the v layers,
a multiple PUSCHs, each including at least one of the v layers, or
a combination of the single PUSCH and the multiple PUSCHs, where a set U₁ of the X panels is used for the single PUSCH and a set U₂ of the X panels is used for the multiple PUSCHs.

16. The method of claim 15, wherein the multiple PUSCHs or the combination of the single PUSCH and the multiple PUSCHs is granted via downlink control information (DCI).

17. The method of claim 11, wherein the UL transmission corresponds to one of:
a codebook (CB)-based transmission, wherein a panel among the X panels includes a group of antenna ports associated with one or multiple sounding reference signal (SRS) resources, each comprising multiple SRS ports,
a non-codebook (NCB)-based transmission, wherein a panel among the X panels includes a group of antenna ports associated with one or multiple SRS resources, each comprising one SRS port, or
a combination of a CB-based transmission and a non-CB-based transmission, where a set V₁ of the X panels is used for the CB-based transmission and a set V₂ of the X panels is used for the NCB-based transmission.

18. The method of claim 17, wherein:
for the CB-based transmission, the information includes:
one or multiple transmit precoding matrix indicators (TPMIs), or
one or multiple TPMIs and one or multiple SRS resource indicators (SRIs), for the NCB-based transmission, the information includes one or multiple SRIs,
each of the one or multiple TPMIs indicates a precoding matrix from a codebook, and
each of the one or multiple SRIs indicates:
for the CB-based transmission, at least one SRS resource with multiple SRS ports, and
for the NCB-based transmission, at least one SRS resource with one SRS port.

19. The method of claim 18, wherein the codebook includes at least one of:
full-coherent (FC) precoding matrices comprising all non-zero entries,
partial-coherent (PC) precoding matrices comprising at least two non-zero entries and remaining zero entries in each column, and
non-coherent (NC) precoding matrices comprising one non-zero entry and remaining zero entries.

20. The method of claim 11, further comprising transmitting UE capability information including an information for support of the UL transmission based on the X panels.
